(19) United States
(12) Patent Application Publication
(10) Pub. No.: US 2023/0342828 A1
(43) Pub. Date: Oct. 26, 2023

(54) System and Method for Controlling Access to a Private Marketplace on Supply Chain Network

(71) Applicant: CHEWY, INC., Dania Beach, FL (US)

(72) Inventors: Mikle SURILOV, Boston, MA (US); Aseemita MALHOTRA, Dania Beach, FL (US); Andrew Alan STREICH, Dania Beach, FL (US)

(73) Assignee: CHEWY, INC., Dania Beach, FL (US)

(21) Appl. No.: 18/255,835

(22) PCT Filed: Dec. 3, 2021
(86) PCT No.: PCT/US2021/061786

§ 371 Date: Jun. 2, 2023

Related U.S. Application Data
(60) Provisional application No. 63/121,040, filed on Dec. 3, 2020.

(51) Int. Cl. G06Q 30/0601

(52) U.S. Cl. CPC G06Q 30/0609

(57) ABSTRACT

A method for controlling access to a supply chain including receiving, on a supply chain network server, a user request identifying a product or service, and in response to the user request, causing a user interface to display information about the product or service that includes identification information about two or more distinct sources for the product or service, the two or more distinct sources including no more than i) a host of the supply chain network server; and ii) a provider associated with a user-specific account.

### CROSS-REFERENCE TO RELATED APPLICATIONS

This application claims the benefit of U.S. Provisional Patent Application No. 63/121,040 filed Dec. 3, 2020 entitled “System and Method for Controlling Access to a Private Marketplace on Supply Chain Network”, which is incorporated by reference herein in its entirety.

### BACKGROUND OF THE INVENTION

The present invention generally relates to a system and method for controlling access to a selectable supply chain resource.

### BRIEF SUMMARY OF THE INVENTION

In one embodiment, there is a method for controlling access to a supply chain including, receiving, on a supply chain network server, a user request identifying a product or service; and in response to the user request, causing a user interface to display information about the product or service that includes identification information about two or more distinct sources for the product or service, the two or more distinct sources including no more than i) a host of the supply chain network server; and ii) a provider associated with a user-specific account. In some embodiments, the information about the product or service further includes a) a first condition for acquisition of the product or service preselected by the host of the supply chain network server, and b) a second condition for acquisition of the product or service preselected by the provider associated with the user-specific account. In some embodiments, the method further includes displaying the first condition proximate identification information of the host of the supply chain network server, and simultaneously with the displaying of the first condition, displaying the second condition proximate identification information of the provider associated with user-specific account information.

In some embodiments, prior to causing the display of the identification information about the provider associated with the user-specific account, the method further includes displaying on the user interface a prompt to associate the user-specific account with the provider. In some embodiments, the prompt includes one or more of: a dropdown menu, a dialog box, a login screen and an icon. In some embodiments, the method further includes verifying that the provider is authorized by the host of the supply chain network server to provide products or services via the marketplace server, and verifying that the provider has authorized association with a user. In some embodiments, the method further includes automatically associating the user request with a prescription authorization from the provider.

In some embodiments, the method further includes, storing in a database, coupled to the supply chain network server, the first condition for acquisition of the product or service and the second condition for acquisition of the product or service, verifying, via the supply chain network server, that the provider is authorized to change the second condition for acquisition, receiving, via the supply chain network server, an updated second condition for acquisition, and storing in the database coupled to the supply chain network server, the updated second condition for acquisition. In some embodiments, causing the user interface to display information about the product or service includes displaying the second condition for acquisition. In some embodiments, the second condition for acquisition includes at least one of: a price, a discount code, prescription information, refill information, usage instructions, a user acknowledgement selection, and third party payer information.

In some embodiments, the requested product or service is at least one of: a pharmaceutical product that requires a prescription, a product that does not require a prescription, digital media, or a telemedicine session, or any other service. In some embodiments, the method further includes receiving, via the supply chain network server, user account data that includes information regarding one or more designated providers associated with one or more pets. In some embodiments the provider associated with the user-specific account is authorized by an entity other than the user to permit the user to access to the product or service.

In some embodiments, the method further includes in response to the user request, causing the user interface to display information about the product or service that includes identification information about an additional source for the product or service wherein the identification information is displayed in a manner that indicates the user is not authorized to obtain the product or service from the additional source. In some embodiments, the provider is associated with the user-specific account based upon a previous transaction between the provider and one or more of an individual associated with the user-specific account and a pet associated with the user-specific account. In some embodiments, the previous transaction includes i) the writing of a prescription; ii) a transaction for the purchase of a good or service that is unrelated to the requested product or service; iii) a registration with the provider; and iv) obtaining an authorization code.

In some embodiments, the user interface is coupled to a user device connected to the supply chain network server by one of a wide area network connection and a local area network connection. In some embodiments, the first condition has a first value and second condition has a second value and first value is different from the second value. In some embodiments, the first condition has a first value and second condition has a second value and first value is the same as the second value. In some embodiments, the method further includes receiving, at the supply chain network server, an order designating the selection of the provider as the source to provide the product or service, and verifying, via the supply chain network server, that a prescription for the ordered product or service has been received for the product or service and the prescription is associated with the user specific account.

In some embodiments, the method further includes receiving, on the supply chain network server, a selection message indicating the provider associated with the user-specific account is a preferred source, and upon receiving, on the supply chain network server, a future user request identifying an additional product or service, causing the user interface to display the provider as a default primary provider for the additional product or service. In some embodiments, prior to causing the user interface to display the provider as a default primary provider for the additional product or service, the method includes verifying that the default primary provider has pre-selected the product or service for inclusion in a provider virtual marketplace. In some embodiments, the method further includes receiving on the supply chain server an indication that a new user and an authorized provider are associated with a transaction initiated on a separate network coupled to the supply chain network, and in response to receive the indication, creating a user record for the new user via the supply chain network server and associated the authorized provider with the user record.

In some embodiments, the method further includes receiving an order placement request, on the supply chain network server, for a product to be sourced from the provider, the product requiring a prescription, querying a database, via the supply chain network server, to verify that a valid prescription with sufficient refills have been associated with the order placement request, recording in the database, an indication that inventory associated with the order has been transferred from a wholesale inventory associated with the supply chain network server to a retail inventory of the provider, receiving, in the database, an indication that the product has been shipped. In some embodiments the method further includes transmitting to a provider server, from the supply chain network server, a transaction message including information relating to provider product inventory status and a net proceeds transactions summary indicating a difference between accrued amounts associated with inventory transferred from the wholesale inventory associated with the supply chain network server and accrued amounts associated with orders, to be sourced from the provider, that were placed with the supply chain network server. In some embodiments, the user request includes one or more of: i) a search request; ii) selection via a menu; iii) a selection via hyperlink; and iv) selection via hyperlink in a digital message from a provider.

### BRIEF DESCRIPTION OF THE SEVERAL VIEWS OF THE DRAWINGS

The foregoing summary, as well as the following detailed description of embodiments of the system and method for accessing a virtual marketplace, will be better understood when read in conjunction with the appended drawings of an exemplary embodiment. It should be understood, however, that the invention is not limited to the precise arrangements and instrumentalities shown.

In the Drawings:

FIG. 1A is a block diagram illustrating an implementation of supply chain network system, in accordance with an exemplary embodiment of the present invention

FIG. 1B is a block diagram illustrating an implementation of a veterinarian pharmacy transaction system, in accordance with an exemplary embodiment of the present invention.

FIG. 1C is a block diagram illustrating a database including user information, product information, and authorized provider information, in accordance with an exemplary embodiment of the present invention.

FIGS. 2A-2G are exemplary user interfaces of a supply chain network, in accordance with an exemplary embodiment of the present invention.

FIG. 2H is a side-by-side comparison of two user interfaces displayed for different users viewing the same product, in accordance with an exemplary embodiment of the present invention.

FIG. 3 illustrates an exemplary flow chart representing a method for controlling access to a supply chain network, in accordance with an exemplary embodiment of the present invention.

FIG. 4 illustrates an exemplary flow chart representing a method of introducing additional product providers to a supply chain network, in accordance with an exemplary embodiment of the present invention.

FIG. 5 illustrates another exemplary flow chart representing a method of introducing additional product providers to a supply chain network, in accordance with an exemplary embodiment of the present invention.

### DETAILED DESCRIPTION OF THE INVENTION

Numerous details are described herein in order to provide a thorough understanding of the example embodiments illustrated in the accompanying drawings. However, some embodiments may be practiced without many of the specific details, and the scope of the claims is only limited by those features and aspects specifically recited in the claims. Furthermore, well-known methods, components, and circuits have not been described in exhaustive detail so as not to unnecessarily obscure pertinent aspects of the embodiments described herein.

Some embodiments of the present invention provide improvements to a virtual supply chain network such as a virtual private or public marketplace. An exemplary virtual public marketplace includes one in which transactions between buyers and/or sellers are facilitated with little or no restriction as to which seller, or provider, offering a desired product or service is selected by a buyer to provide that product or service. An exemplary private marketplace is limited in the number of buyers and sellers and in some cases, restricts the sale and/or supply of some goods and services among only those entities who are authorized to participate in the private marketplace (e.g., buyers and sellers who consent to transactions over the private marketplace). In one example of a private marketplace on a virtual supply chain network, only certain sellers or providers who transact business over the virtual supply chain network (e.g., 1, 2 or more sellers or providers) who may be among many other sellers or providers of a particular product or service are able to sell or provide the products or services to certain buyers. In one embodiment, Buyer 1 searching a private marketplace associated with a virtual supply chain network for a desired product or service may be presented with only a limited option of sellers or providers. For example, only Provider A and Provider B, based upon an authorization for Buyer 1, are able to transact business with Buyer 1, via the virtual supply chain network. In this example, there may also be Providers C and D who are also sellers or providers of the product over the virtual supply chain network, but Providers C and D are not authorized to be associated with Buyer 1 and thus, Buyer 1 is not provided the option of buy the product from Providers C and D. Providers C and/or D, however, may be authorized to be associated with another buyer. That other buyer, however, may not be associated with Provider A and/or Provider B and thus would not be presented with an option to transact with Provider A and/or Provider B respectively. It should be understood, that over time, Providers C and/or D might become associated with Buyer 1, as described herein for example, and would then be presented as transaction options for Buyer 1.

In one embodiment, enhanced authentication and/or authorization systems and methods streamline product and service distribution and transactions by providing the purchasers of goods and/or services with automatically curated access to selected providers. The selected providers may include, for example, a provider that is hosting the virtual supply chain network and a provider that meets a predefined criteria for automatic identification as an available resource for a particular client of the supply chain network. In some embodiments, the provider hosting the virtual supply chain network is identifiable by branding on the user interface that identifies the host as the branded entity. In other embodiments, the host of the virtual supply chain network is the back-end system provider operating the virtual supply chain network. In some embodiments, the network operator is the branded host. In some embodiments, network operator host permits one or more branded entities to be associated with the front end (e.g., user interface) of the virtual supply chain network and wherein the operator-host operates the system on behalf of the one or more branded entities. Predefined criteria may include, for example, prior authorization status of buyer, seller and/or provider and a prior verified transaction between the parties (e.g., a buyer was previously authorized to transact with a particular provider or seller or category of providers or sellers; a provider or seller was previously authorized to transact with a buyer or category of buyers or as otherwise described herein)

In one embodiment, the private marketplace may include a personalized marketplace. For example, Buyer 1 may designate a preferred service criteria (e.g., a pet owner may designate a particular pet as a preferred service criteria for personalization). Once the preferred service criteria is designated for the private marketplace, products or services that are the subject of an authorized transaction between Buyer 1 and Providers A and B in association with the preferred service criteria are available for Buyer 1 to initiate a transaction or for a transaction to be initiated on behalf of Buyer 1. In one example, a buyer named Sally may identify her dog Spot as a preferred service criteria on the virtual supply chain network. An established private marketplace on the virtual supply chain network may have been previously created between Sally and her veterinary clinic ABC Vets. Sally searches for heartworm medicine through her authorized access to the virtual supply chain network. ABC Vets has previously been established by the virtual supply chain network as an authorized seller and/or provider of the heartworm medicine and has designated WormAway as being an appropriate medicine for Spot (e.g., by breed, age, another criteria). In response to Sally's search, Sally would be presented on her client device, a private marketplace option to obtain WormAway from ABC Vets for Spot.

In one embodiment, one or more databases relate (e.g., via relational databases and/or non-relational databases) supply chain network clients (e.g., providers, endorsers, purchasers) to products and or services that may be available from a host distributor (e.g., a host of a supply chain network server). In one example, supply chain network clients include endorsers, proponents and/or advertisers of a particular product or service. In some embodiments, an endorser, proponent and/or advertiser is presented to a user as a provider although a separate entity (e.g., a marketplace host) may be handling multiple (e.g., most or all) of transaction management to process and order and deliver the product or service to a user or purchaser. The marketplace host may, for example, operate a back-end system and permit one or more of the separate entities to brand the front end of the system as it chooses.

Exemplary databases, such as a relational or non-relational database, coupled to a selectable supply chain network server are updatable through client devices associated with authenticated and/or authorized accounts. In one example, the authenticated and/or authorized accounts are associated with a service provider. Once authorized and/or authenticated through a client device as being associated with a particular service provider, the service provider designates which products and services are associated with the authenticated and/or authorized account in the database. Another example of authenticated and/or authorized accounts are accounts associated with users who may be interested in acquiring products or services through the supply chain network. Once authorized and/or authenticated through a client device as being associated with a particular user, the user designates criteria that is used to automatically associate the user with a particular service provider and therefore, the products or services designated by the service provider. Designation criteria may be for example, properly identifying a particular provider, a service provider indicia (e.g., a code that may unique be associated with the provider in the database), prior transaction information that associates the service provider and the user based upon a prior transaction between the service provider and the user.

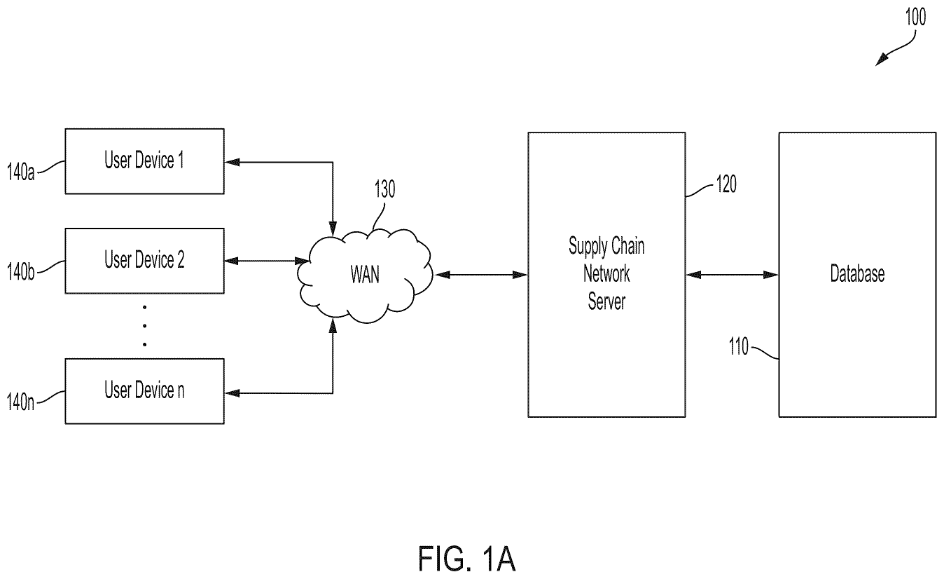

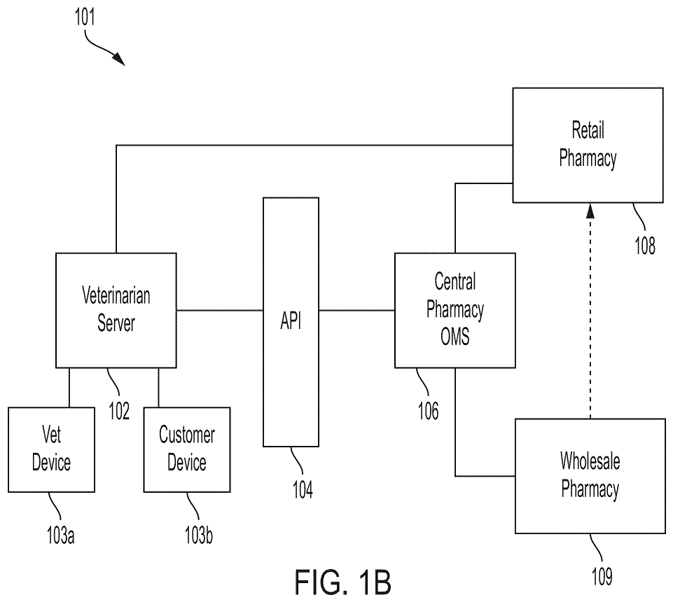

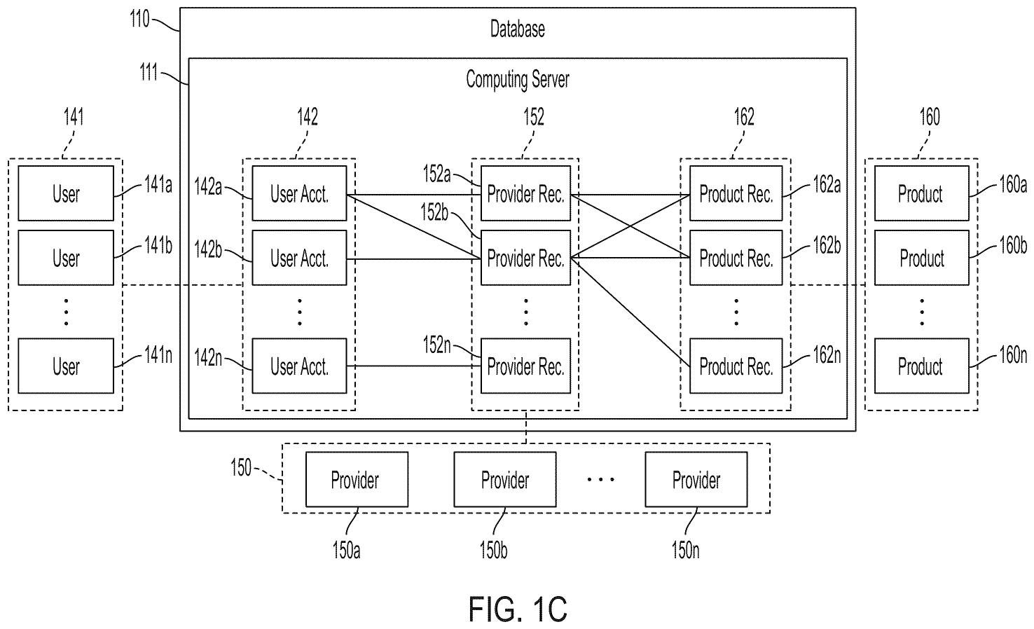

In some embodiments, the system operates by integrating non-wholesale product providers with at least some portions of a supply chain network backend system that fulfils orders on behalf of the non-wholesale product provider thereby allowing non-wholesale product providers to sell products directly to customers without physically stocking products or maintaining their own supply chain network. Referring to the drawings in detail, wherein like reference numerals indicate like elements throughout, there is shown in FIGS. 1-5 a method and system for managing a personalized supply chain, in accordance with an exemplary embodiment of the present invention.

Local providers, such as veterinary clinics, typically have limited access to large scale technology platforms, such as an online marketplace platform, that allow them to provide products and/or services to their customers outside of what happens in their clinic. These local providers must also often compete with larger retailers and other providers which offer the same or similar products and/or services via a large online marketplace platform. Therefore, there is a need to provide these veterinary clinics, for example, with access to a private technology platform that connects the veterinary clinic with their customers, allowing the veterinary clinic to provide products and/or services to said customers through a technology platform that might include a public marketplace platform, private marketplace platform or a marketplace platform that flexes to include a private marketplace platform. Providing veterinary clinics access to a large-scale private technology platform in this manner allows the veterinary clinics to compete with large scale wholesale providers.

Referring to FIGS. 1A-1C, there is shown a system for managing a personalized supply chain. While some example features are illustrated, various other features have not been illustrated for the sake of brevity and so as not to obscure pertinent aspects of the example embodiments disclosed herein. To that end, as a non-limiting example, the system 100, as illustrated in FIG. 1A, includes a database 110, and a supply chain network server 120. WAN 130 and one or more User Devices 140a-140n.

In one embodiment, supply chain network server 120 includes one or more computing servers that execute server-side portions of the application software of the invention. Supply chain network server 120 may provide a user device 140 with secure access to product data located in the database 110. Exemplary user device 140 illustrated in FIG. 1A includes a computer, a laptop computer, a tablet device, a netbook, an internet kiosk, a personal digital assistant, a mobile phone, a smart phone, a gaming device, a computer server, or any other suitable computing device. One aspect of the supply chain network server 120 is configured to generate a user interface (UI) which is accessible via a network (e.g., wide area network 130, or the Internet) and is viewable by a user (e.g., customer, veterinarian, clinic or hospital staff and/or other approved authorized users) on a user device 140. The user device 140 includes a display device connected to or integral with the user device 140 for displaying the user interface.

One aspect of database 110 includes one or more computing servers 111 which store information necessary to fulfill orders placed on the supply chain network server 120. In some embodiments, the supply chain network server 120 is configured to present product listings and settle transactions. Embodiments of database 110 stores at least one of user data, product data, and product provider data (e.g., as discussed in more detail with reference to FIG. 1C). In some embodiments the marketplace server 120 is integrated with the database 110.

Referring to FIG. 1B, in one embodiment there is shown a system 101 in accordance with an embodiment of the present invention. In one embodiment, the system 101 includes a veterinarian server 102, an application platform interface (API) 104, central pharmacy order management system (OMS) 106, retail pharmacy server 108, and wholesale pharmacy server 109. In one embodiment, veterinarian server 102 provides a user device 103 (e.g., veterinarian device 103a, and/or customer device 103b) with secure access to pharmaceutical product data located in a database on veterinarian server 102. The system 101 may include the system discussed in more detail in international publication number WO2020243544 which is incorporated by reference in its entirety herein. In one embodiment of the present invention, a supply chain network is implemented using some of the systems and methods described in WO2020243544. For example, in one embodiment, a provider may utilize the system of FIG. 1B to offer products to users over a private marketplace via Veterinarian Server 102. Upon completion of a transaction between a user of customer device 101b and the provider (e.g., a veterinarian or clinic) via veterinarian Server 102, data received at Central Pharmacy OMS 106, Retail Pharmacy 106 or Wholesale Pharmacy 110 is used to automatically establish or confirm a relationship between the user of supply chain network of the present invention and a provider. Upon establishing or confirming the relationship between the provider and the user on the supply chain network, a user later accessing the supply chain network of the present invention (which for example, may be separate from the veterinarian server 102 network) would have access to transaction details associated with the separate Veterinarian server 102. In some embodiments, upon establishing or confirming the same relationship, an authorized user later accessing the supply chain network of FIG. 1A would have access to a private retail marketplace between the user and provider associated with Veterinarian Server 102 through supply chain network of FIG. 1A. In one embodiment, that private retail marketplace would arise from the user navigating (e.g., via search operations or otherwise) to a product or service page on the supply chain network and being presented, via a client device authorized by the network, with an option to acquire the product or service from provider associated with veterinarian server 102.

FIG. 1C is a block diagram illustrating and embodiment of a database including user information, product information, and authorized provider information, in accordance with an exemplary embodiment of the present invention. In FIG. 1C, illustrate database 110 includes user accounts 142a-142n, generally designated 142, for one or more users 141a-141n, generally designated 141, provider records 152a-152n, generally designated 152 for one or more providers 150a-150n, generally designated 150, and product/service records 162a-162n, generally designated 162 for one or more products/services 160a-160n, generally designated 160. Each user account 142 included in database 110 includes records and/or information relating to a corresponding user 141.

Referring to FIG. 1C, in some embodiments, the database 110 stores data (e.g., records for user accounts 142, and/or provider records 152) associated with one or more account holders (e.g., one or more users 141, and/or one or more providers 150), and data (e.g., product records 162) associated with one or more products or services 160. The database 110 also stores information about relationships between one or more of the data associated with user accounts 142, the one or more provider records 152, and the one or more products or service records 162. The data associated with the one or more user accounts 142 may identify a user 141 associated with the host of the supply chain network server 120. For example, user account 142a identifies user 141a, user account 142b identifies user 141b, and user account 142n identifies user 141n. The data associated with the one or more user accounts 142 may identify the user 141 as any one of: a user which is not an account holder, a user which is an account holder, an individual account, a family or joint account, a pet owner, or a user authorized by a pet owner (e.g., family and/or friends of the pet owner). In some embodiments, the data associated with a user account record 142 may include information associated with one or more animals or pets owned by the user 141 associated with the user account 142. In some embodiments, a provider 150 includes any third-party retailer associated with a host of the supply chain network server 120. In some embodiments, a provider 150 associated with the host of the supply chain network server 120 is a provider 150 which the host has authorized to receive orders from the host. In some embodiments, a provider 150 associated with the host of the supply chain network server 120 is a provider 150 which has previously done business with or through the host. In some embodiments, the provider 150 includes any one of: a veterinarian clinic, an individual veterinarian, a hospital, or an individual practice within a hospital.

In some embodiments, the data associated with the one or more user accounts 142 includes an indicator as to whether a provider 150 associated with the user's account 142 is a preferred or available source for products and services 160 offered on the supply chain network server 120. For example, as shown in FIG. 1C, user account 142a is associated with provider record 152a, and provider record 152b, indicating that user 141a is associated with provider 150a and provider 150b. The data associated with user account 142a may include an indication that the user 141a associated with user account 142a selected to have provider 150a as a preferred source for products and/or services 160. In some embodiments, if a user account 142 includes a listing of a provider 150 as a preferred source, the system 100 may display that provider 150 as a default primary provider for a product or service requested by a user associated with said user account 142. In some embodiments, a default provider 150 associated with a user is based on a preselected preferred provider criteria. In one embodiment, a user may preselect a specific pet (or, for example, information related to a pet such a species, bread, or another characteristic) as the preferred provider criteria to be associated with a particular user account 142. In one embodiment, the preselected preferred provider criteria is automatically populated in a database record associated with the user's account. Automatic preselection may arise when a user having an authorized account associated with the supply chain network participates in a transaction with a provider who also has an authorized account with the supply chain network. Upon the entry of transaction information via the supply chain network server, details of the transaction may serve as the basis for defining preselected preferred provider criteria. In one embodiment, user account 142a may also be associated with a first pet and a second pet. The default primary provider for the first pet is, for example, provider 150a while the default primary provider for the second pet is provider 150b. In some embodiments, a provider 150 associated with a pet included associated with user account 142 is determined, by the system 100, to be the default primary provider 150 when it is the only provider 150 associated with that pet included in the user account 142. It will be understood that a default primary provider may refer to a provider 150 that is associated with a user account 142 or a pet included in the user account 142.

In some embodiments, a default primary provider is a provider 150 that is automatically associated, by the system 100 with a product 160 requested for display by a user 141. In some embodiments, displaying a provider 150 includes displaying indicia and/or images on a user facing user-interface, by the supply chain network server 120, identifying the provider 150. In some embodiments, the indicia and/or images displayed in this manner are included in a corresponding provider record 152 stored on database 110. For example, displaying provider 150a on a user facing user-interface includes displaying indicia and/or images stored in provider record 152a on database 110, which identify provider 150a (e.g., the name of provider 150a, a logo associated with provider 150a). Continuing the example from above, future requests (e.g., a request which has not yet been received by the system 100) to view products or services sent by the user 141a to the supply chain network server 120 would display said product or service with an indication that provider 150a as an available provider for that selected product or service. In some embodiments, provider 150a is displayed as a default primary provider for user account 142. In some embodiments, provider records 152 include provider account data. In some embodiments, provider 150 is displayed as a provider (e.g., a default provider, primary provider or available provider) for a product or service 160 only after the provider account meets pre-defined display criteria. The pre-defined display criteria includes, in some embodiments, one or more of i) the provider 150 selection status of the product or service 160, ii) a relationship status between the provider 150 and the user 141, or iii) a relationship status between the provider 150 and the patient (e.g., a particular pet that may or may be associated with a user account 142). In one aspect of the provider account, for example, a provider 150 may designate one or more products or services (e.g., product 160a) from a larger menu of products or services 160 to be associated with the provider account. For example, in the context of a veterinary clinic as the provider 150 embodiment, a particular veterinary clinic (or a particular veterinarian with a clinic), may preselect two preferred medications to treat or prevent heartworms from a list of a dozen of such available options. The database associated with the veterinary clinic (or the particular veterinarian within the clinic) would reflect that provider's 150 selection of the two heartworm medications. Thus, when a user 141 in association with a user account 142 associated with the particular veterinary clinic (or veterinarian within the clinic) searches for heartworm medications via the marketplace server 120, the option to purchase the two particular heartworm medication selected by the provider 150 associated with the user account 142 will be displayed. In some such cases, only the two preselected products will be displayed to that user 141. In other embodiments, the two preselected products will be displayed in a manner to indicate that they are recommended (e.g., recommended by the user's clinic or veterinarian). In other embodiments, all dozen products may be displayed, but only when a user 141 selects one of the two preselected products, will the user see the option to purchase the product from the provider.

In some embodiments, a user-selected preferred provider (e.g., provider 150a) is the default primary provider for all products or services 160 offered on the retail marketplace server 120. In some embodiments, the default primary provider may be selected on a per-product basis. For example, user account 142a is associated with provider 150a and provider 150b. If user 141a associated with user account 142a requests to display information about product 160a, provider 150a may be displayed as the default primary provider. Additionally, if user 141a associated with user account 142a requests to display information about product 160b, provider 150b may be displayed as the default primary provider. In some embodiments, the system 100 may determine the default primary provider based on whether or not the product requires a prescription. For example, if user 141a associated with user account 142a requests to display product or service 160a which requires a prescription, and provider 150a has provided a prescription to the user for product or service 160a but provider 150b has not, provider 150a would display as the default primary provider.

In some embodiments, the system 100 is configured to determine the default primary provider on a per animal/pet basis. In some embodiments, the user account 142 stored on database 110 includes data identifying one or more pets/animals owned by the user 141 associated with the user account 142. For example, if user account 142a includes data identifying a first pet and a second pet, the first pet may be associated with provider 150a while the second pet is associated with provider 150b. In this example, the providers 150a and 150b may be different veterinarian clinics (or different veterinarians within a single clinic) where the user associated with user account 142a takes their pets for check-ups and treatments. The first pet and second pet may be the same type of pet (e.g., both dogs) or they may be different types of pets (e.g., the first pet is a dog and the second pet is a cat). If the user has selected to view a product or service 160 and has indicated that the selected product or service 160 is for the first pet, provider 150a would be displayed as the default primary provider for the selected product or service 160.

In some embodiments, the data associated with a user account 142 may include a data identifying alternate providers. In some embodiments, the data identifying alternate providers include a provider 150 associated with the user account 142 which is not referenced in the database as a default primary provider. In some embodiments, the system 100 may display an alternate provider as the default for a selected product or service 160, which the alternate provider offers, if the default provider has opted not to offer that product or service 160. In some embodiments, a user associated with the user account 142 may rank their preferred alternate providers.

In some embodiments, the data associated with a user account 142 includes one or more shipping addresses (e.g., to which products or services 160 purchased by a user may be delivered). In some embodiments, a user account 142 is associated with a default or primary shipping address from the one or more shipping addresses. In some embodiments, the data associated with a user account 142 includes a record of products or services 160 purchased by a user 141 associated with the user account 142. In some embodiment, the record of products or services 160 purchased by the user 141 may include at least: product info, product quantity, shipping address, payment method used, previous sources from which the product or service was ordered, previous sources of other products or services ordered by a user associated with the account, and a confirmation that the product was delivered. In some embodiments, the data associated with a user account 142 includes insurance coverage data associated with the user account 142.

In some embodiments, the database 110 stores information input by, for or on behalf of one or more providers 150. In some embodiments, information stored on the database 110 in this manner is added to a provider record 152 associated with the provider 150. In some embodiments, a provider 150 provides information to associate the provider 150 with a user 141 by associating the provider record 152 with a user account 142. For example, provider 150a inputs information associating the provider 150a with user 141a, the information is added to provider record 152a and database 110 creates an association between provider record 152a and user account 142a. In some embodiments, the association of the provider 150 with a user account 142 is automated. For example, if provider 150a writes a prescription for user 141a associated with user account 142a, and uploads that prescription to the system 100, the system 100 automatically causes the database 110 to update to include the association between user account 142a and provider record 152a. In some embodiments, the system 100 determines that a user account 142 is associated with a provider 150 through records indicating a previous transaction between the user account 142 and provider 150. In some embodiments, the previous transaction includes any one of: the writing of a prescription, a transaction for the purchase of a product or service 160 that is unrelated to a currently requested product or service 160, a registration with a provider 150, and obtaining an authorization code (e.g., a QR code, a code provided in mail sent from a provider 150 to a user, a hyperlink displayed on a provider 150 associated website).

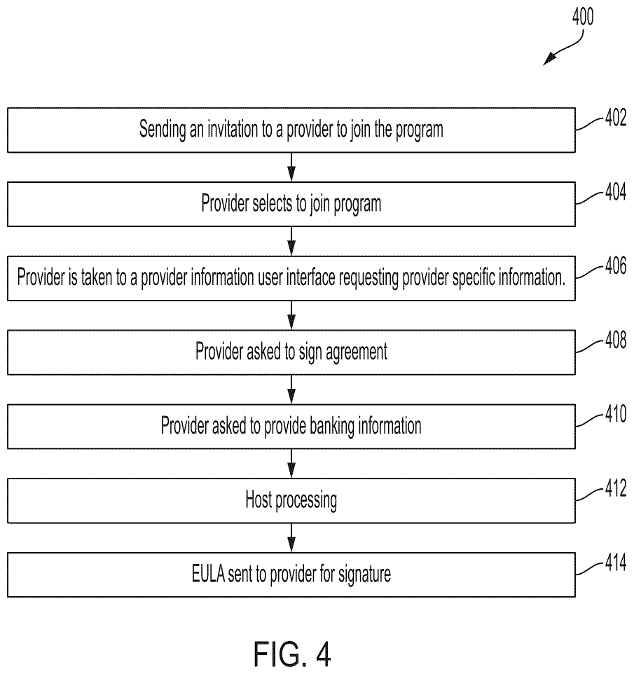

In some embodiments, a provider 150 must complete an onboarding process (e.g., method 400 shown in FIG. 4) before the provider 150 may be associated with one or more of the products 160 offered by the host of the supply chain network server 120. For example, the onboarding process may include: the host inviting a provider 150 to complete the onboarding process, the provider 150 furnishing provider specific information to be included in a provider record 152 stored on database 110, the host processing the information received from the provider 150, and the provider 150 signing an end user license agreement received from the host. In some embodiments, a new provider record 152 is stored in the database 110 in response to a provider 150 completing the onboarding process. In some embodiments, an existing provider record 152 is updated in the database 110 in response to a provider 150 completing the onboarding process. In some embodiments, completion of the onboarding process creates an association of a provider record 152 with one or more product records 162 in database 110. In some embodiments, database 110 may store provider records 152 associated with providers 150 which have not completed the onboarding process shown in FIG. 4. For example, database stores provider records 152n which is associated with provider 150n which has not completed the onboarding process. Providers 150 which have completed the onboarding process are shown in FIG. 1C as having at least one association from the corresponding provider record 152 to a product record 162.

In some embodiments, the database 110 stores provider records 152 associated with any provider 150 that has a recorded transaction with the host of the supply chain network server 120. In some embodiments, the database 110 includes provider records 152 associated with any provider 150 that has sourced transactions to customers of the provider 150 through the supply chain network server 120. In some embodiments, the database includes provider records 152 associated with providers 150 which have no previous or current association with either of a user account 142 or product 160.

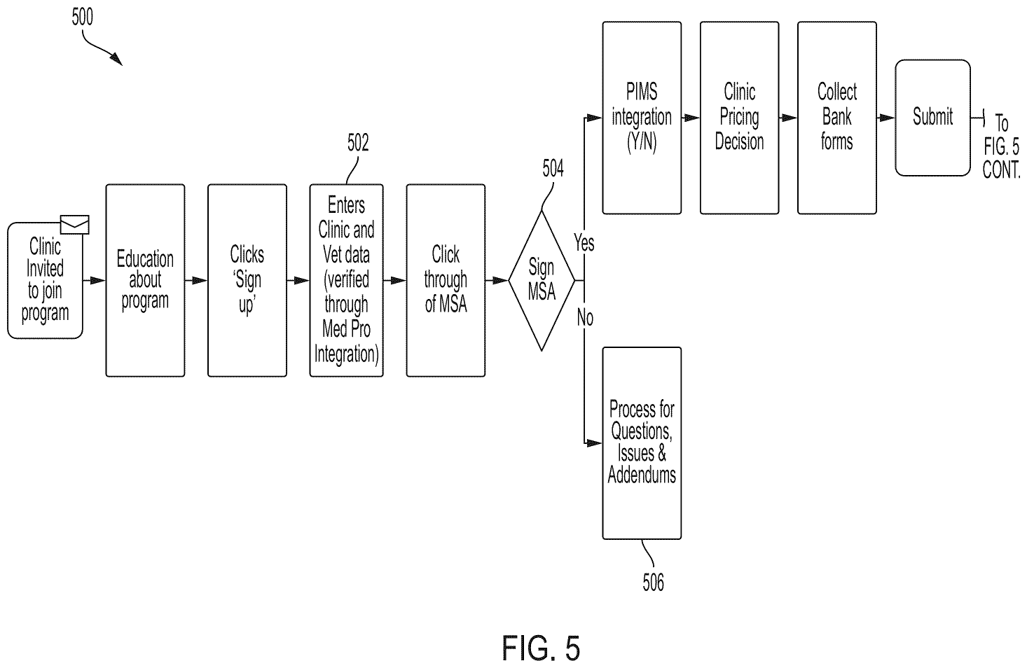

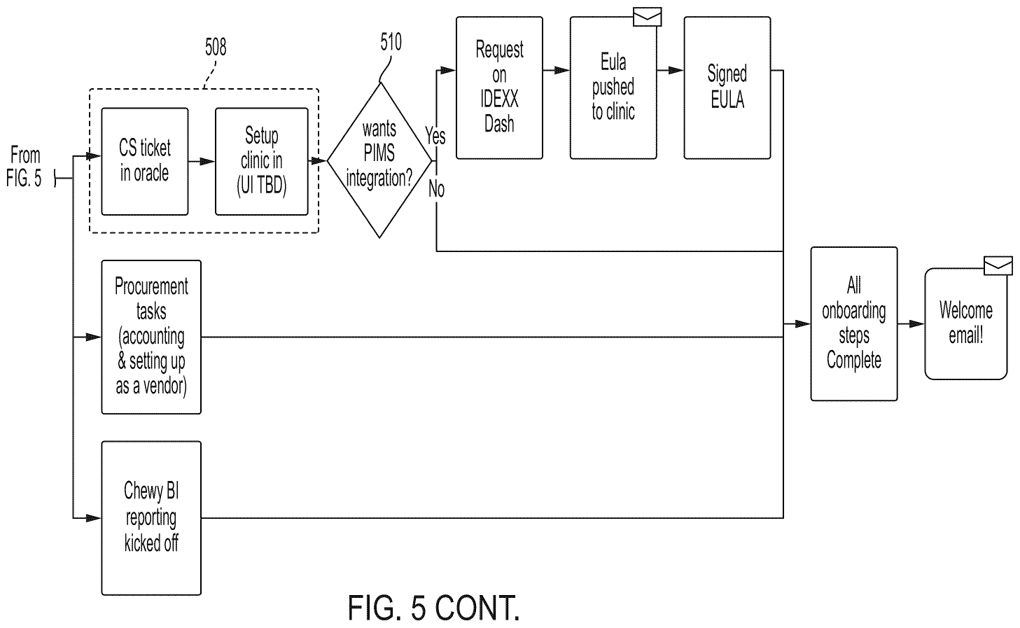

In some embodiments, the database 110 stores information relating to associations between one or more of users 141, providers 150, products or services 160 and the host of the supply chain network server 120. As described above, a user 141 may be associated with one or more provider 150 by an association of the user's 141 user account 142 and the provider's 150 provider record 152 stored in database 110. It will be understood that an association of the user account 142 and provider 150 indicates that the user 141 is associated with the provider 150, and that the user account 142 is associated with the provider record 152 in database 110. In some embodiments, the association of the user account 142 and provider 150 is established based on criteria that includes any one of: a user indication that the user wishes to associate their account 142 with a provider 150, a record of a previous transaction between a user associated with a user account 142 and a provider 150, and information received from a provider 150 (e.g., provider 150 causing user information which corresponds to user accounts 142 to be associated with the provider 150 and/or associates of the provider 150). In some embodiments, an association between a user account 142 and provider 150 is only established when both the user 141 associated with the user account 142 and the provider 150 agree to the association (e.g., through an electronic acknowledgement or the grant of a permission). In some embodiments, an association between the user account 142 and provider 150 is only established when the user associated with the user account 142 requests or agrees to the association. In some embodiments, before an association between a user account 142 and provider 150 can be established, the provider 150 must have completed the onboarding process shown in FIG. 4 or FIG. 5. In some embodiments, a user 141, is able to establish the association between their user account 142 and a provider 150 by providing, at a user device 140 in communication with the supply chain network server 120, an indication that the provider 150 is a provider 150 with which they do business. In some embodiments, a provider 150 is establishes an association between their provider record 152 and a user account 142 which the provider 150 creates on behalf of a user 141, as described below in more detail.

In some embodiments, the system 100 is configured to display on a user device 140 only those providers 150 that are within a certain geographic range (e.g., of a user device location or of a user-specified location). In some embodiments, the system 100 is configured to display on a user device 140 only those providers 150 that are within 1 mile, 2 mile, 3 mile, 4 mile, 5 mile, 6 mile, 7 mile, 8 mile, 9 mile, 10 mile, 11 mile, 12 mile, 13 mile, 14 mile, 15 mile, 16 mile, 17 mile, 18 mile, 19 mile, or 20 mile radius of a shipping address (e.g., associated with an order, a provider location, a user location, a device location or a specified location). In some embodiments, the system 100 is configured to display on a user device 140 only those providers 150 that the user 141 has previously provided a rating for. In some embodiments, a user 141 associated with a user account 142 may remove an association with a provider or block a provider 150 such that the system will not display that provider 150 to the user associated with the user account 142. In some embodiments, a provider 150 may remove an association with a user account 142 or block the user account 142 such that the system will not display that provider 150 to the user associated with the user account 142.

As mentioned above, in one embodiment, the system 100 stores product records 162 corresponding to a plurality of products 160. Products 160 may also include services offered by the host of the retail marketplace server 120 or a provider 150. In some embodiments, the database 110 stores product records 162 corresponding to products 160 which may be offered for sale by the retail marketplace server 120. In some embodiments the product records 162 stored for any given product 160 may include one or more of: a SKU number, a product name, status of inventory (e.g., available, total number available, or unavailable), gross price, and margin percentage. In some embodiments, the product 160 may be a prescription medication, a non-prescription medication, a service, digital media, or any other item offered on the retail marketplace server. In some embodiments, the product records 162 corresponding to a product 160 or service includes an indication as to whether or not the product 160 or service requires a prescription to purchase the product 160. In some embodiments, the product records 162 corresponding to a product 160 or service may include a user account 142 specific indication as to how many prescription refills are remaining for that product 160. For example, user account 142a may have five refills remaining for product 160a while user account 142b may only have three refills remaining, the refill amounts included in product records 162a and 162b respectively.

In some embodiments, product records 162 stored on the database 110 include conditions of purchase for the products 160. In some embodiments, the product records 162 stored on database include a first condition for purchase of a product 160 and a second condition for purchase of the same product 160. In some embodiments, the first condition is a retail price established by the host of the supply chain network server 120. In some embodiments, the second condition is a retail price(s) set by different respective provider(s) 150 associated with the product 160. In some embodiments, the second condition includes at least one of: a price, a discount code, prescription information, refill information, usage instructions, a user acknowledgement selection, and third-party payer information. In some embodiments, a product (e.g., product 160a) is associated with a second condition to acceptance of an order for that product that is set by a first provider (e.g., provider 150a) and a second condition to acceptance of an order for that product set by a second provider (e.g., 150b). In some embodiments, the second condition set by different providers 150 may be the same or different. For example, product record 162a, corresponding to product 160a, may include a second condition of a purchase price of $49.99 set by provider 150a and a second condition of a purchase price of $49.99 set by provider 150b. Alternatively, the retail price included in the second condition set by provider 150b may be a different dollar amount (e.g., $52.99). In some embodiments, product records 162 may include that a provider 150 has included a discount for a specific product 160 that is only valid for an amount of time set by the provider 150 (e.g., a 10% discount for product 160a until a specific date). In some embodiments, the product records 162 stored on database 110 corresponding with products 160 includes: a host retail price, a host retail price with insurance, a provider price, and a provider price with insurance.

In some embodiments the system 100 is configured to associate one or more products 160 with one or more providers 150. In some embodiments, the database 110 stores an association between providers 150 and products 160. In some embodiments, the association between providers 150 and products 160 is included in one or more of the provider records 152 and product records 162 stored in database 110. In some embodiments, a provider 150 must complete an onboarding process (as referenced above and as discussed in more detail below with reference to FIG. 4) before an association between said provider 150 and the one or more products 160 recorded in database 110 can be associated. In some embodiments, a provider 150 which has completed the onboarding process choses to be associated with all products 160 which have corresponding product records 162 stored in database 110. For example, a provider 150 accesses the retail marketplace server 120 via a user device 140 which displays a user interface allowing the provider 150 to input a selection to be associated with all products 160 offered for sale by the retail marketplace server. In some embodiments, a provider 150 which has completed the onboarding process may choose to be associated with a portion of all the products 160 recorded in database 110. For example, a provider 150 accesses the supply chain network server 120 via a user device 140 which displays a user interface allowing the provider 150 to individually selection to be associated with all products 160 offered for sale by the retail marketplace server.

In some embodiments, the product records 162 stored on database 110 includes information about corresponding products 160 (e.g., to condition a purchase) that is set by an associated provider 150 for said products 160. As mentioned above, a provider 150 may choose to match a host retail price, offer a product 160 for a price which is different from the host retail price, or establish a conditional retail price (e.g., volume discount, regional discount, insurance related discount, a user-specific one-time discount). In some embodiments, a provider 150 which has completed the onboarding process shown in FIG. 4, may select the products 160 which are displayed, or not displayed to a user account 142 associated with the provider 150. Displaying a product 160 to a user account 142 refers to displaying said product 160 on a user interface transmitted from the retail marketplace server 120 to a user device 140. The user device 140 being operated by a user 141 who is associated with the user account 142. In some embodiments, association of a user 141 with a user account 142 requires that the user 141 authenticate with the user account 142 (e.g., log in to the user account 142) through the supply chain network server 120. For example, provider 150b may select only products 160a and 160n, but not 160b for display to a user 141 associated with user account 142a accessing the system 100. In some embodiments, if more than one provider 150 is associated with a single user account 142, a product 160 may not be displayed to the user account 142 if any one provider 150 has restricted access to it for the specific user account 142. For example, if provider 150b has restricted access to product 160b for user account 142a, regardless of whether provider 150a restricts access to product 160b, product 160b will not be displayed to user account 142a. In some embodiments, if more than one provider 150 is associated with a single user account 142, a product 160 may only not be displayed if all of the providers 150 associated with the user account 142 have restricted access to it for that user account 142. For example, if provider 150b chooses to restrict access to product 160b for user account 142a, but provider 150a has not restricted access or has specifically chosen to display product 160b to user account 142a, product 160b will be displayed to user account 142a.

In some embodiments, system 100 is configured to allow providers 150 that have completed the onboarding process shown in FIG. 4 to designate certain products 160 to be visible only to certain classes of user accounts 142. In some embodiments, user account 142 classes are determined by one or more pets associated with the user account 142. For example, the system 100 is configures such that only user accounts 142 that associate a user 141 with a horse would have authority, as designated by a provider 150 associated with that user account 142, to be able to purchase products 160 related to horses, and user accounts 142 that associate a user 141 with a dog would be able to purchase products 160 relating to dogs, etc. In some embodiments, providers 150 may only limit display and availability of products 160 which require prescriptions to certain classes of user accounts 142. In some embodiments, providers 150 are permitted to endorse one or more products 160. In some embodiments, products 160 which are endorsed by providers 150 are displayed to a user account 142 associated with that provider 150.

UI Walkthrough

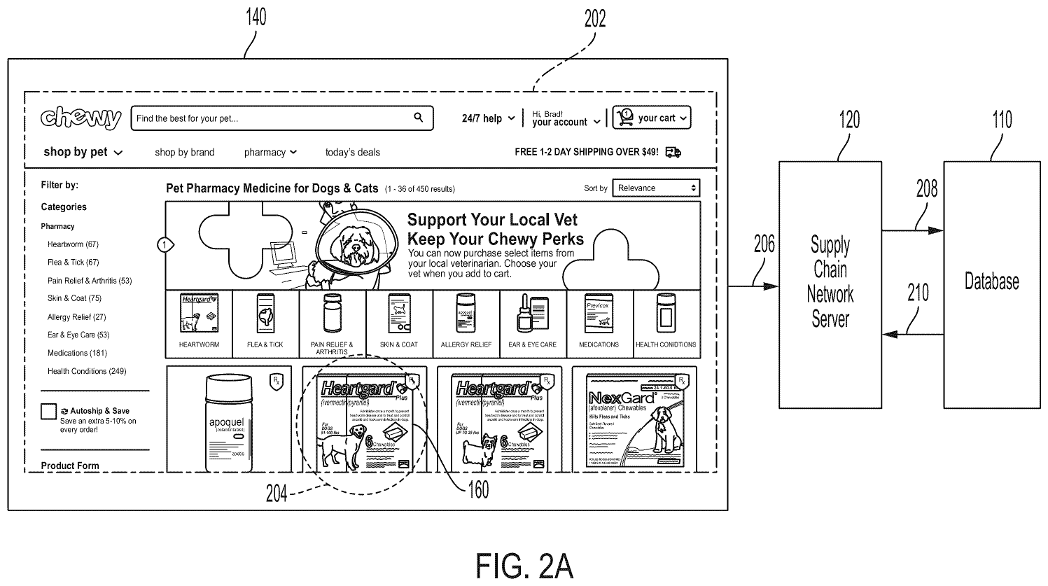

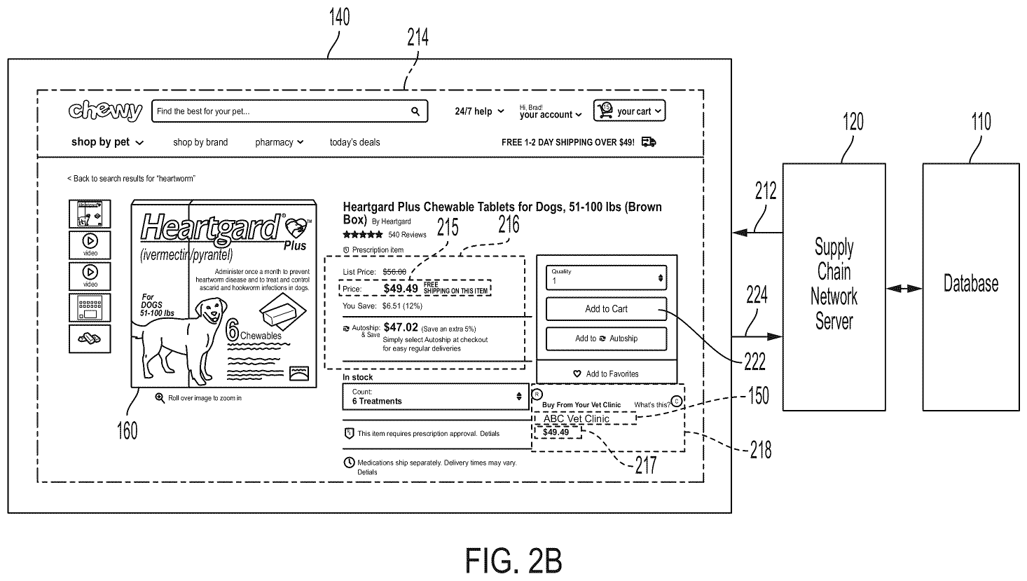

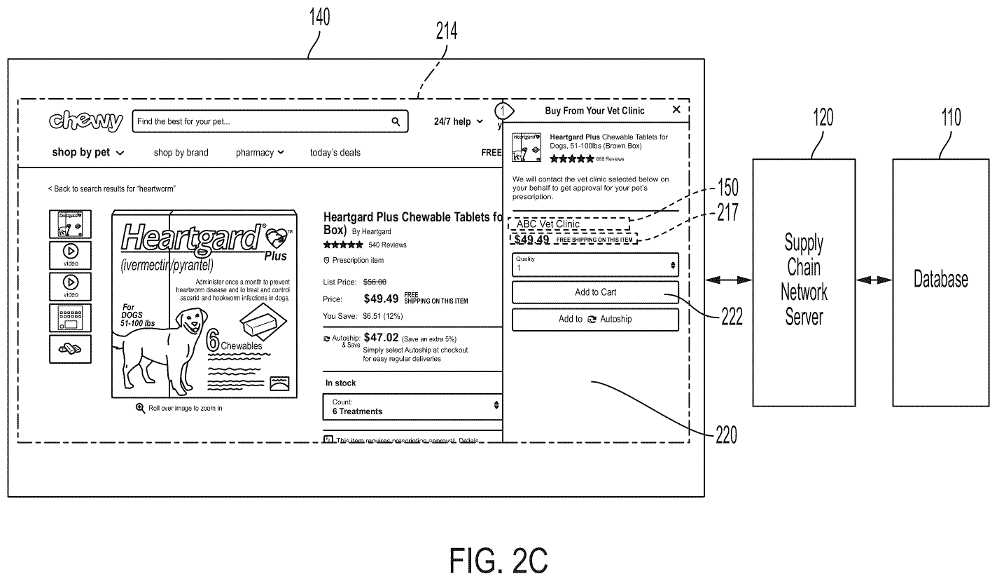

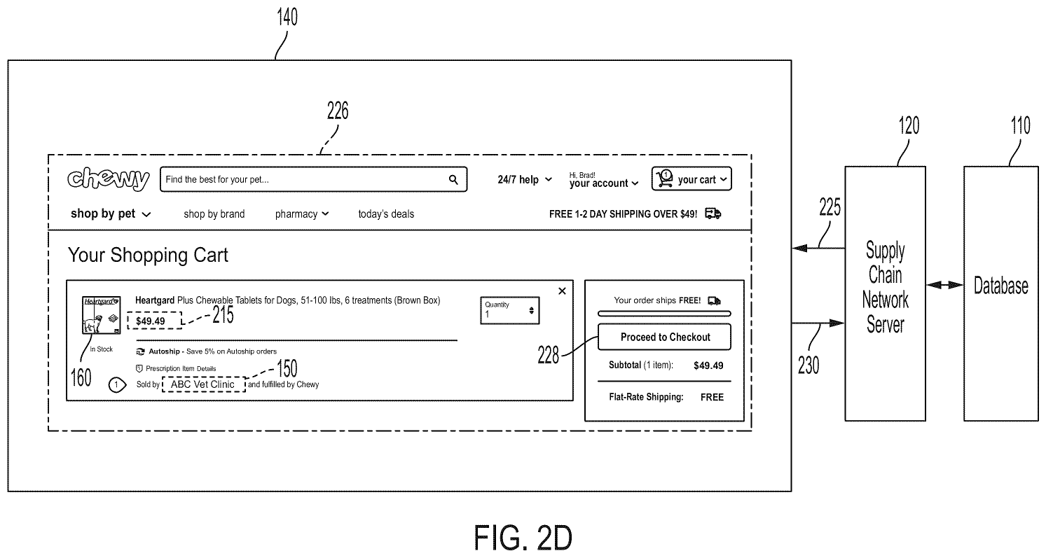

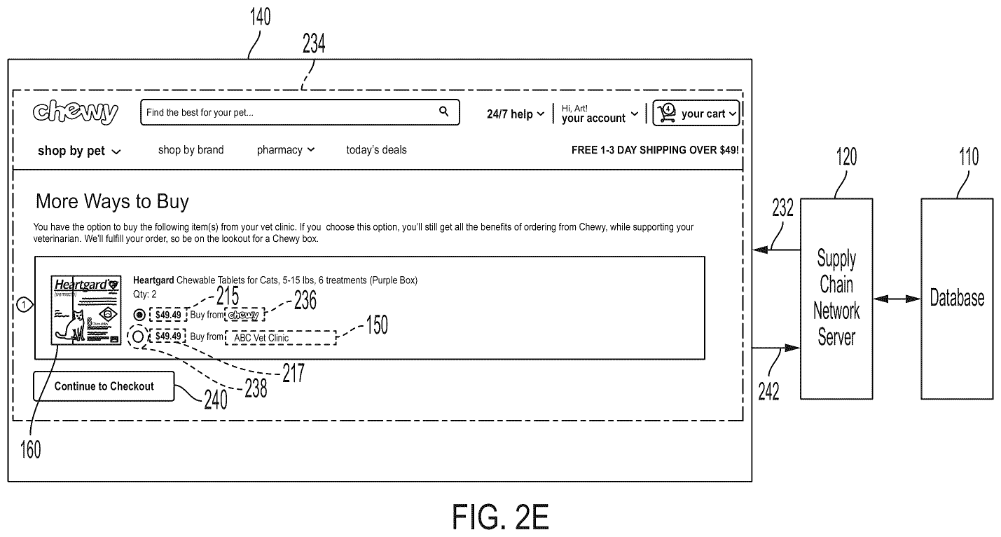

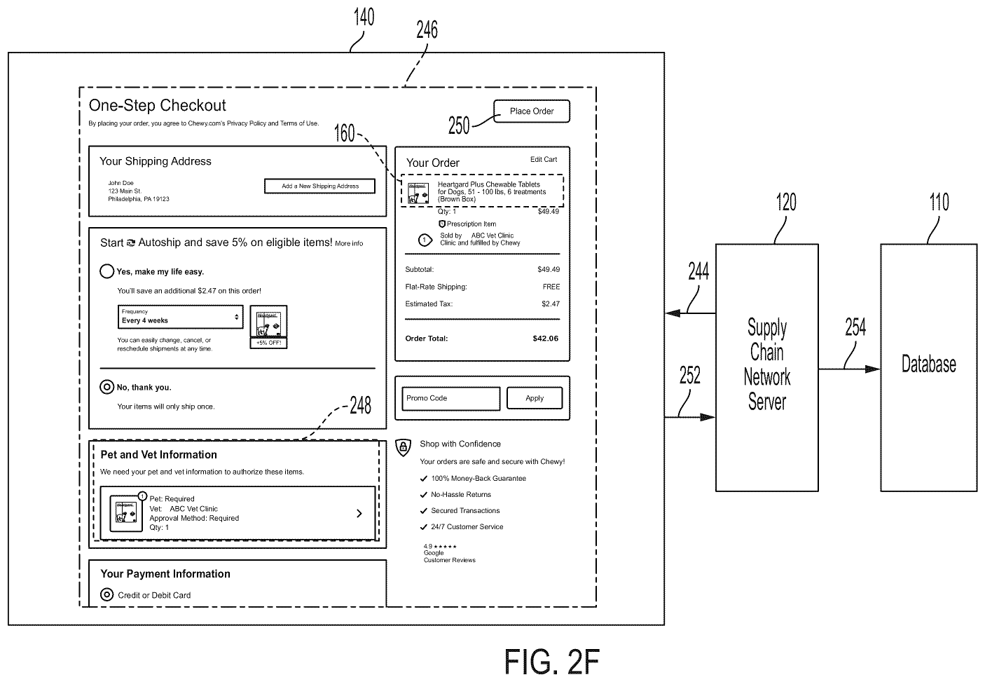

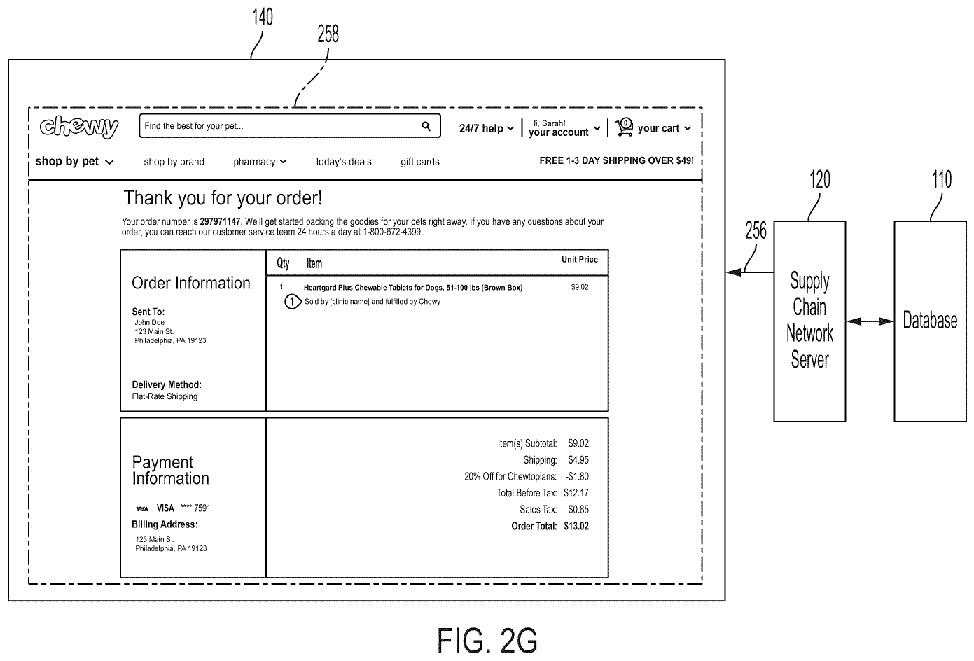

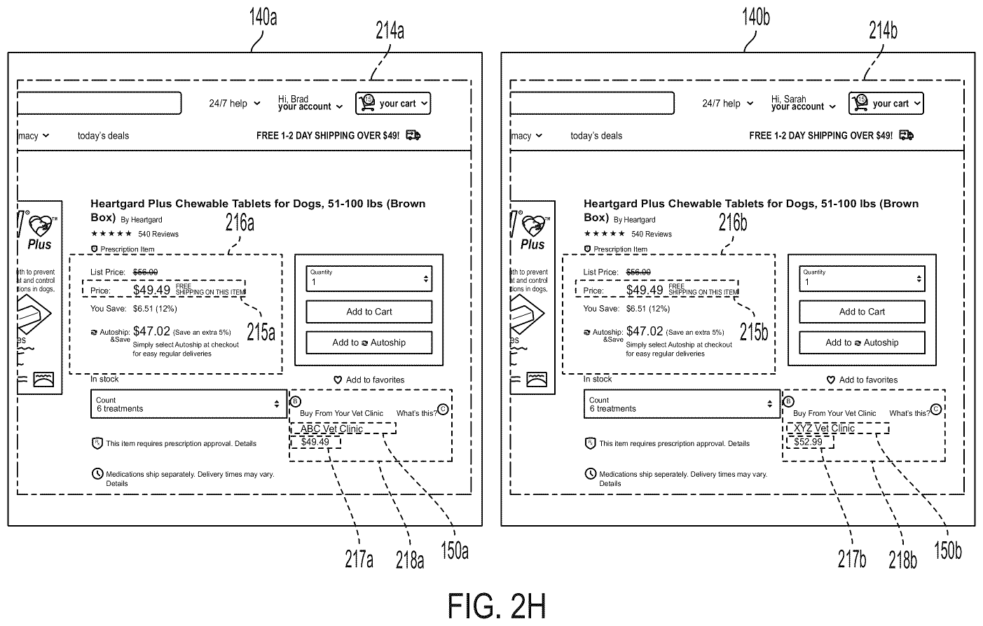

Referring to FIGS. 2A-2H, there are shown exemplary user interfaces (UI) for a virtual retail marketplace that connects a user with local providers for a product. As shown in FIG. 2A, a user 141, via user device 140, has accessed the supply chain network server 120. The supply chain network server 120 has transmitted a homepage UI 202 which the user device 140 is displaying. In the homepage UI 202 displayed in FIG. 2A, the user 141 is already logged in to their associated user account 142. However, a user 141 may at any point in the UI shown in FIGS. 2A-2E log into their associated user account 142 or create a new user account 142 if they do not currently have one. Additionally, at any point in the UI shown in FIGS. 2A-2E, the user 141 may choose to edit, delete or add account information to their associated user account 142 (e.g., a pet, a veterinarian clinic, a new shipping address, a new payment method). For the sake of brevity, the exemplary UI's shown in FIGS. 2A-2H are taken from the perspective of a user 141 logged in to their associated user account 142 which includes association of a pet and a provider 150 (e.g., a veterinarian clinic) associated with that pet. The term default, when used in reference to a user-interface, refers to the user-interface as it is displayed on the user device 140 prior to any input by the user 141.

In FIG. 2A, the user 141 provides an input at location 204, indicating that the user 141 would like to request information identifying a product or service (e.g., a product 160 having a corresponding product record 162 stored in database 110). The requested product or service 160 shown in FIG. 2A is a prescription medication for treating heartworms in dogs, however the requested product or service 160 may be a product which does not require a prescription, digital media, or a telemedicine session. In this example, the user 141 provides an input on an already displayed product 160, however the user 141 input may have been any one of: a search request (e.g., the user inputs “diet dog food” into a search bar), a selection via a menu (e.g., the user selects “heartworm” from a displayed pharmacy menu), a selection via a hyperlink (e.g., a hyperlink displayed in an email or website that directs them to a product description page for a specific product), and a selection via a hyperlink in a digital message from a provider 150 (e.g., the user receives a hyperlink in an email from their veterinarian clinic which directs them to a product description page for a specific product).

In response to the user input at location 204, a user request 206 is sent from the user device 140 to the supply chain network server 120. In response to the user request 206, the virtual retail marketplace server is configured to transmit a product information request 208 to database 110. The product information request 208 includes an indication of what product 160 was requested by the user. In response to the product information request 208, the database 110 is configured to transmit product information 210, included in the product record 162 corresponding to the selected product or service 160, to the virtual retail marketplace server 120. In some embodiments, the product information 210 transmitted from database 110 includes information indicating whether or not a prescription for the selected product 160 has been authorized by provider 150. In some embodiments, the system 100 automatically, in response to the request 206, is configured to associate the request 206 with a previous prescription authorization from the provider 150 to the user account 142 for the selected product 160. In some embodiments, the system 100 is configured to automatically check to see if there are any refills remaining for the selected product 160.

In FIG. 2B, in response to the user request 206, and in response to receiving the product information 210, the supply chain network server 120 is configured to transmit product description UI information 212 to user device 140. In response to receiving the product description UI information 212, user device 140 displays a product description UI 214. The product description UI 214 shown in FIG. 2B displays information about the selected product or service. The displayed information includes a first condition 215 displayed in the area 216 and a second condition 217 displayed in area 218. The first condition 215 displayed includes a retail price set by the host of the supply chain network server 120. The second condition 217 includes a retail price set by a provider 150 associated with the user (e.g., the user's veterinarian clinic associated with the user's account 142). In FIG. 2B, both the first condition 215 and second condition 217 have the same retail price, however, the prices displayed in this way may have different values. The provider 150, and second condition 217 displayed here may be different for different users. Also displayed in area 218 is a listing of the selected provider 150 (in this instance a single provider associated with the user account).

For example, referring to FIG. 2H, portions of two different user interfaces 214a and 214b are displayed on different user devices 140a and 140b. Different users 141a and 141b are accessing the virtual retail marketplace server 120 after sending requests to the virtual retail marketplace server 120 for the same product. The two users 141a and 141b are associated with two different user accounts (e.g., user account 142a, and user account 142b). The two different user accounts 142a and 142b are associated with two different providers 150a, and 150b. The displayed first condition 215a, and 215b are the same and the displayed second conditions 217a, and 217b are different. In FIG. 2H the second condition 217b displays a retail price of $52.99 sourced by provider 150b (e.g., XYZ Vet Clinic), while the second condition 217a displays a retail price of $49.99 sourced by provider 150a (e.g., ABC Veterinary Clinic). It will be understood that the prices and providers displayed here are examples. Both users may be associated with the same provider (e.g., both users associated with ABC Vet Clinic). The different providers shown here may also have set the same retail price (e.g., both providers 150a, and 150b set a price of $49.99, or any other dollar amount).

Returning to FIG. 2B, the second condition 217 may be displayed in a manner that indicates the user is not authorized to obtain the product or service 160 from the provider 150. For example, the indicia displayed within the second condition 217 may be grayed out and/or include additional indicia indicating that the user is not authorized (e.g., indicia stating “Not Authorized”, “Further Authorization Required”). In some embodiments, a second condition 217 displayed in this manner indicates that a provider 150 associated with the user account 142 has not completed the onboarding process shown in FIG. 4.

Still referring to FIG. 2B, the area 218 may display zero, one, two, or more than two providers. For example, one provider (e.g., ABC Veterinary Clinic) is displayed in area 218 in FIG. 2B. However, if the user account 142 is associated with more than one provider 150 (e.g., associated with two different veterinary clinics) display area 218 may include an interactable feature allowing the user 141 to select from the one or more providers 150 associated with their account 142. The interactable feature may be a dropdown box, a series of radio selection buttons, or any other feature that permits the user to input information such as making a selection from presented options. In some embodiments, one or more of the providers 150 are displayed in a manner that indicates the user 141 is not authorized to obtain the product or service 160 from said provider 150, as discussed above. In some embodiments, if there are no providers 150 associated with the user account 142, area 218 displays a message indicating to the user 141 that no providers 150 are associated with their account 142. It will be understood that areas 216 and 218 for displaying the first and second conditions 215 and 217 may appear in a plurality of locations on the product description UI 214 (e.g., displayed vertically, horizontally, adjacent one another, or non-proximal one another).

Still referring to FIG. 2B, in some embodiments, area 218 displays providers 150 not previously associated with the user account 142. In some embodiments, the system 100 is configured to display providers 150 in response to the system 100 identifying that the user account 142 has no association with any provider 150. In some embodiments, the system 100 is configured to display providers 150 in response to the system 100 identifying that the user account 142 has zero, fewer than 2, fewer than 3, fewer than 4, or fewer than 5 associated providers 150. In some embodiments, the system 100 is configured to display providers 150 displayed based on a geographic distance between a shipping address included in the users account 142 and a providers 150 place of business. In one embodiment, the providers 150 displayed in this manner are only providers 150 which have completed the onboarding process, shown in FIG. 4.

Still referring to FIG. 2B, a user 141 may, via user device 140, select from one or more product options. The product options may be one or more of: product quantity, desired purchasing frequency (e.g., auto-ship or auto-order options which automatically place an order for the product at a user specified time interval), and order count. Additional product options may include size, color, and bundle packages including the selected product 160 and one or more other products 160 suggested by the host of the supply chain network server 120 or a provider 150 associated with the user account 142.

In one embodiment, display area 218 includes an interactable feature that allows the user 141 to view additional information about the selected provider 150 and/or second condition 217. For example, FIG. 2C shows a modal window 220 within product description UI 214. The modal window 220 displays additional information about the selected provider 150 and second condition 217 such as the shipping cost associated with purchasing the selected product 160 from provider 150, and prescription authorization approval process required to purchase the selected product 160 (which may include, for example, reference to the veterinarian, clinic or medical professional associated with user 141 and/or associated with the selected product requiring prescription authorization). In some embodiments, modal window 220 displays one or more of the product options displayed on product description UI 214. Modal window 220, shown in FIG. 2C, displays a quantity selection, and a desired purchasing frequency option as described above.

Returning to FIG. 2B, the user 141 provides an input at button 222 corresponding to the ‘Add to Cart’ option, indicating that the user 141 wishes to add the displayed product 160 to a virtual shopping cart. Alternatively, the user 141 may provide the input at button 222 on modal window 220 shown in FIG. 2C. In response to the user input at button 222, supply chain network server 120 receives a shopping cart request 224 from the user device 140. In some embodiments, a user 141 may have previously selected an auto-ship option (which option may be stored in association with the user), displayed for example in FIGS. 2B-2C, and FIG. 2F, for product 160. In one embodiment, if the user 141 selected the auto-ship option for product 160, the system 100 automatically places the order for product 160 without displaying any of the user-interfaces shown in FIGS. 2B-2F to the user 141.

Referring to FIG. 2D, there is shown a shopping cart UI 226 displayed on a user device. The shopping cart UI 226 includes a display of the selected product 160, the first condition 215, indicia indicating the provider 150 and an interactable button 228. In response to the shopping cart request 224, the supply chain network server 120 is configured to transmit shopping cart UI information 225 to user device 140. In response to receiving the shopping cart UI information 225, the user device 140 displays a shopping cart UI 226 to the user. The shopping cart UI 226 displays the default purchasing options associated with the user account 142. In this example the default options displayed are the first condition 215 for purchasing the selected product 160, and the provider 150 associated with the user account 142. However, the shopping cart UI 226 may display the second condition 217 for purchasing the selected product 160 if provider 150 is recorded as a default purchasing option in the user account 142, and the provider 150 is associated with the selected product 160. In some embodiments, the shopping cart UI 226 displays the second condition 217 for purchasing the selected product 160 instead of the first condition 215. The shopping cart UI 226 also displays an interactive quantity field, which allows the user 141 to change the quantity of the selected product 160 they would like to purchase, the shopping cart total which is the sum total of the price of all products included in the shopping cart and a shipping cost. In this example, only one product 160 is selected for purchase at a quantity of one, however, additional products may be displayed here. In FIG. 2D, the user 141 provides input at button 228 indicating that the user 141 would like to proceed to checkout. In response to the user input at button 228, user device 140 transmits a first checkout request 230 to marketplace server 120.

Referring to FIG. 2E, there is shown a purchasing source UI 234 displaying an indication of the selected product 160, the first condition 215, host identification 236, the second condition 217, an indication of the provider 150, and an interactable button 240. In response to the first checkout request 230, supply chain network server 120 is configured to transmit purchasing source information 232 to user device 140. In response to receiving the purchasing source information 232, user device 140 displays a purchasing source UI 234 to allow the user 141 to make a selection of which source (e.g., provider 150, or the host of the supply chain network server 120) to purchase the selected product 160 from. The purchasing source UI 234 displays the product(s) 160 selected for purchase as well as the first condition 215 proximate host identification 236, and the second condition 217 proximate identification information for the provider 150.

In FIG. 2E, the first condition 215 is the option selected by default, however the second condition 217 may be displayed as the default selection if the provider 150 is recorded as a default provider in the user account 142, as described above. In this figure only one product 160 was selected for checkout. However, multiple products 160 and/or multiple providers 150 may be displayed on the purchasing source UI 234.

Alternatively, the purchasing source UI 234 may not be displayed in response to the supply chain network server 120 receiving the first checkout request 230. In some embodiments, the system 100 is configured to provide the user 141 with a selection of which source (e.g., host of the supply chain network server 120, provider 150) to purchase the selected product 160 from at the product description UI 214 shown in FIG. 2B. In some embodiments, the purchasing source UI 234 is displayed after the user has made a selection of the purchasing source via the product description UT 214 in order to allow the user 141 to confirm and/or change their selection.

In FIG. 2E, the user 141 provides an input at location 238 corresponding to a radio button displayed on purchasing source UI 234, indicating that the user 141 would like to select the provider 150 as the source for purchasing the product 160. The user 141 then provides an input at button 240 to continue to checkout. In response to receiving the input at button 240, user device 140 transmits a second checkout request 242 to supply chain network server 120.

Referring to FIG. 2F, there is shown a checkout UI 246 displayed on the user device 140. The checkout UI 246 displays an indication of the selected product 160, an area 248 which displays a request for additional information from the user 141, and an interactable button 250. In response to receiving the second checkout request 242, the marketplace server 120 is configured to transmit checkout UI data 244 to user device 140. In response to receiving the checkout UI data 244, the user device displays a checkout UI 246 to allow the user 141 to review and/or edit information about their order before submitting the purchase. The order information displayed on checkout UI 246 includes: shipping address, automatic purchasing frequency selection, provider information (e.g., the pet and vet information), payment information, listing of product(s), individual price of product(s), quantity for each selected product, order total, and a discount code option. In some embodiments, the system 100 is configured to provide the user 141 with the capability of editing some or all of the information displayed on the checkout UI 246. The user 141 may also return to a previous user interface displayed in any one of FIGS. 2B-2E, to edit order information before returning to the checkout UI 246. In some embodiments, the system 100 is configured to display checkout UI 246 with a request for additional information in area 248. In FIG. 2F, area 248 displays a request for required pet and veterinarian information which requires input from the user 141.

Shown in area 248, the system 100 generates a message to be shown on the user device 140 requesting that the user 141 input pet and veterinarian information. In the illustrated embodiment, the pet information is required, and the approval method is required. Examples of pet information includes one or more of: species, name, and age. Examples of approval methods include one or more of: a prescription. The requested pet information may be a selection of a pet associated with the user account 142. In some embodiments, required information is automatically populated with information retrieved from database 110. For example, if the user has only one pet associated with their account the system 100 is configured to automatically populate the required pet information. Additionally, if the selected product 160 is associated with only one type of pet on the users account (e.g., the product 160 is cat weight loss food and the user 141 has a cat and dog associated with their account 142) the system is configured to automatically populate the required pet information with the cat information stored on the database under the user account 142. In some embodiments, the system 100 is configured to display a request for the user 141 to input a selection of a pet associated with their user account 142. For example, if the user 141 has zero, one, two, three, or more than three pets associated with their account 142, and area 248 may display a request for the user 141 to select or provide a pet from the pets associated with their account 142. In some embodiments, multiple pets may be simultaneously selected by the user 141. In some embodiments, if the selected product 160 does not match the selected pet, the system 100 is configured to request that the user provide an acceptable pet selection (e.g., if the product is a horse medication and the user has selected a cat, the system 100 may require that the user provide a selection of a horse as the pet). In some embodiments, the order may not be placed until the user 141 has provided an acceptable pet selection.

In FIG. 2F, illustrates a user display in which a user 141 can provide an input at button 250 indicating that the user would like to purchase the selected product 160. In response to the user input at button 250, user device 140 transmits an order placement request 252 to the supply chain network server 120. In response to receiving the order placement request 252, the supply chain network server 120 transmits to the database 110 an order fulfillment request 254. The order fulfillment request includes a query on the database 110 to verify that a valid prescription with sufficient refills is associated with the order. In response to receiving the order fulfillment request 254, an indication that inventory associated with the order (e.g., selected product 160 and the quantity thereof) has been transferred from a wholesale inventory associated with the virtual retail marketplace server to a retail inventory for the selected provider 150 is recorded in database 110. The supply chain network server 120 also, in response to receiving the order fulfillment request 254, transmits to the provider 150 a transaction message including information relating to the provider's 150 product inventory status and a net proceeds transactions summary indicating a difference between accrued amounts associated with inventory transferred from the wholesale inventory associated with the supply chain network server 120 and accrued amounts associated with orders, to be sourced from the provider 150, that were placed with the supply chain network server 120.

Referring to FIG. 2G, there is shown an order confirmation UI 258 displayed on the user device 140. In response to the order placement request 252, the supply chain network server 120 transmits to the user device 140 order confirmation information 256. The supply chain network server 120 may process the payment for the order prior to transmitting the order confirmation information 256 to user device 140. In response to receiving the order confirmation information 256, user device 140 displays an order confirmation UI 258. The order confirmation UI 258 shown in FIG. 2G indicates that the order was successfully placed. However, the order confirmation UI 258 may indicate that there was an order with processing the payment for the order, that the selected product is out of stock, or that an error occurred resulting in the order not being placed.

In some embodiments, a provider 150 can place an order for a product 160 or service offered for sale on the supply chain network server 120 on behalf of a user 141. In some embodiments, the provider 150 interacts with a user interface displayed on a user device 140 that is in communication with the supply chain network server 120 to place the order. For example, provider 150a can place an order for product 160a on behalf of user 141a and have the order fulfilled by the host of the supply chain network server 120. In one embodiment, the provider 150 places and order for a user 141 having a user account 142 stored on database 110. In some embodiments, orders placed by a provider 150 for a user 141 having an associated user account 142 are displayed to the user 141 when the user 141 accesses the supply chain network server 120. For example, an order is placed to purchase product 160a by provider 150a and ship product 160a to user 141a associated with user account 142a. The user 141a, accesses the supply chain network server 120 via user device 140a, and logs into their associated user account 142a. The user 141a, via user device 140a, is able to view the order placed for product 160a in a user-interface (not shown) generated by the supply chain network server 120. In another embodiment, the provider 150 is able to place an order for a user 141 who does not have a user account 142 stored on database 110. In some embodiments, an order for a user 141 placed in this manner creates a new user account 142 that is associated with the user 141 and stored in database 110. In some embodiments, a provider record 152 associated with the provider 150 who placed the order, is automatically associated, by the system 100, to the newly created user account 142. In some embodiments, a user account 142 created in this manner includes one or more of: the user's name, the user's email address, a pet owned by the user, and the user's shipping address. In some embodiments, the user 141 is able to authenticate with the user account 142 created by the provider 150, via the supply chain network server 120.

In some embodiments, a provider 150, associated with provider record 152, is authorized via supply chain network server 120, for example to associate a pet record with a user account 142. In one embodiment, the provider may only associate pet record with a user account if the pet is associated with the provider record 152. The provider may associate the pet with user records via the supply chain network server 120. For example, if provider 150a wishes to provide products 160 and/or services for a pet owned by user 141a associated with user account 142a and that pet is not currently associated with user account 142a, the provider 150a is able to make that association with the user account 142a. In some embodiments that associated is made with a link between pet records and user records or by adding reference to the pet in the user record. In some embodiments, a provider 150 may authorize a user account 142 to purchase products 160 and/or services in response to a communication from the user 141 associated with the user account 142. For example, if a user 141 wishes to purchase a prescription product (e.g., a dietary food, prescription medication) for a pet associated with their user account 142, the user 141 communicates the request to provider 150 (e.g., via supply chain network servicer 120, via Veterinarian Server 102, or via another communication resource on the network or off the network). In response to the user's request, for example, the provider 150, via the supply chain network server 120, associates a prescription authorization for said product 160 with the user account 142. In one embodiment, the prescription authorization is associated with the user account through the Veterinarian Server 102 and, through a link via supply chain network 120, the user account associated with supply chain network 120 is updated with the corresponding record. Alternatively, the provider 150 may also place an order for that product 160 on behalf of the user 141, via the supply chain network server 120.

In some embodiments, a provider 150, when placing an order for a user 141 having an associated user account 142 stored on database 110, is provided with a provider facing user interface (not shown) by the supply chain network server 120 in order to place the order. In some embodiments, the provider facing user interface includes a display of input fields to allow the provider 150 to input user 141 specific information required to place the order. For example, the input fields may include one or more of: user name, pet name, product, prescription, quantity, shipping address, and payment method. In some embodiments, the product input field is a search bar that includes a display which is automatically populated, by the supply chain network server, with products 160 matching the search parameters input by the provider 150. In some embodiments, the product input field includes an indication of whether or not a product 160 is in stock. In some embodiments, the system 100 is configured to display indicia identifying users 141 having associated user accounts 142 stored on database 110 in response to input from provider 150 at the user name input field. For example, if provider 150a is placing an order for a user with the name “John Doe”, the system 100, displays user accounts 142 including a user name of “John Doe” to the provider. In some embodiments, the user account 142 includes an email address of the user 141 which the provider 150 may input into the user name input field in order to identify the user 141.

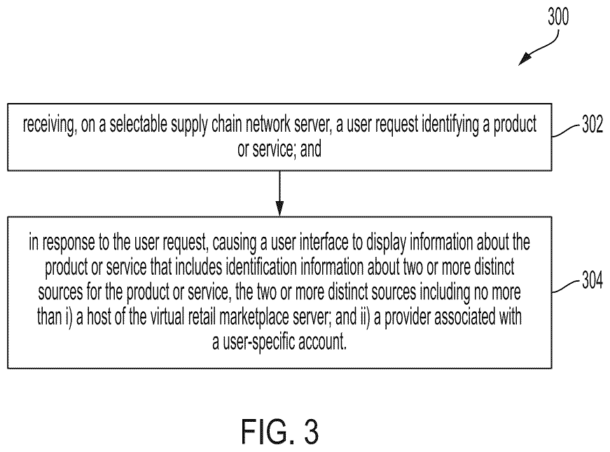

Referring to FIG. 3, there is shown, a flow diagram of an exemplary method 300 for displaying selectable supply chain resource such as a private or public marketplace server. In an embodiment, method 300 includes a step 302 of receiving, on a selectable supply chain network server (e.g., supply chain network server 120 of FIG. 1A), a user request (e.g., user request 206 in FIG. 2A) identifying a product or service (e.g., product 160 in FIG. 2A). In an embodiment, method 300 also includes the step 304 of, in response to the user request (e.g., user request 206 in FIG. 2A), causing a user interface (e.g., product description UI 214 in FIG. 2B) to display information about the product or service (e.g., product 160). In one embodiment, the displayed information includes identification information about two or more distinct sources for the product or service. In one embodiment, distinct sources are different entities (e.g., different sellers of a product or service) that control their own pricing and/or their own product or service menu. In one embodiment, although the sources may control their own pricing and product or service menu, one of the distinct sources may utilize the infrastructure of another provider. In one embodiment, one of the sources for the product or service includes a host of the supply chain resource (e.g., a private or public marketplace server such as supply chain network server 120). In another embodiment, one of the sources for the product or service includes a supply source that is a distinct commercial enterprise from the host. In one embodiment, the two or more distinct sources include no more than i) a host of the virtual supply chain resource (e.g., host of supply chain network server 120); and ii) a provider associated with a user-specific account (e.g., provider 150 associated with user account 142). In one embodiment, the host of the virtual supply chain resource is an entity that controls access to the virtual supply chain resource (e.g., a website host). In one embodiment, the provider associate with a user-specific account includes an entity that database 110 indicates is associated with the account of a registered user of the virtual supply chain resource. The provider may be associated with the user-specific account in any of the ways described herein including, for example, as a previous supplier of a good or service to the user, as service provider to the user (e.g., as veterinarian for a pet of the user); as a doctor that has previously prescribed a product or service for a user (e.g., a veterinarian that has written a drug or treatment prescription for a pet of the user).

In an embodiment, the information about the product or server further includes a) a first condition (e.g., first condition 215 in FIGS. 2B, and 2E) for acquisition of the product or service preselected by the host of the virtual retail marketplace server, and b) a second condition (e.g., second condition 217 in FIGS. 2B, and 2E) for acquisition of the product or service preselected by the provider associated with the user-specific account.

In some embodiments, the method 300 further includes the steps of displaying the first condition proximate identification information of the host of the virtual supply chain resource server (e.g., displaying a price of a drug near an identification of a host of the supply chain resource e.g., host identification 236). In some embodiments, simultaneously with the displaying of the first condition, the method 300 includes displaying the second condition proximate identification information of the provider associated with user-specific account information (e.g., displaying a second price for the same product but the price reflects the price for the user if the user was to purchase the product the veterinarian of the user). In one example, the first condition 215 and second condition 217 displayed on purchasing source UI 234 in FIG. 2E are each displayed proximate information identifying the host of the supply chain network server 120 and the provider 150 associated with the user account 142 respectively.

In one embodiment, the method 300 also includes displaying on the user interface, a prompt to associate the user-specific account with the provider. In one embodiment, the prompt is displayed prior to causing the display of the identification information about the provider associated with the user-specific account. Thus, prior to FIG. 2E, for example, the user may be presented with a prompt for the user to associate their account 142 with a provider 150. In some embodiments, the prompt includes one or more of: a drop-down menu, a dialog box, a login screen, and an icon. For example, the prompt asking the user to associate their account 142 with a provider 150 may be a drop-down menu including a listing of different providers 150 stored on database 110, a dialog box asking the user to input prover info, a login screen asking the user to log into an account 142 or an icon requesting the same.

In an embodiment, the method 300 may further comprise the steps of verifying that the provider is authorized by the host of the virtual retail marketplace service to provide products or services via the marketplace server; and verifying that the provider has authorized association with a user. For example, the supply chain network server 120 may query the database 110 to check if the provider 150 for the selected product 160 in FIGS. 2B-2G has an association with the selected product 160 as described above with reference to FIG. 1C. The supply chain network server 120 may also query the database 110 to see if the information stored on the database 110 for the provider includes an indication that the provider 150 is associated with the user account 142.

In an embodiment, the method 300 may further comprise the step of automatically associating the user request with a prescription authorization from the provider. For example, the system 100 may automatically, in response to request 206 in FIG. 2B, associate the request 206 with a previous prescription authorization from the provider 150 to the user account 142 for the selected product 160.

In some embodiments, the method 300 may further comprise the step of storing in a database, coupled to the virtual retail marketplace server, the first condition for acquisition of the product or service and the second condition for acquisition of the product or service. In some embodiments, the method 300 may further comprise the step of authenticating, via the virtual retail marketplace server, that the provider is authorized to change the second condition for acquisition. In some embodiments, the method 300 may further comprise the step of receiving, via the virtual retail marketplace server, an updated second condition for acquisition. In some embodiments, the method 300 may further comprise the step of storing in the database coupled to the virtual retail marketplace server, the updated second condition for acquisition. In some embodiments, causing the user interface to display information about the product or service includes displaying the second condition for acquisition. For example, database 110 stores the retail prices for products 160 set by both the host of the supply chain network server 120 and providers 150 which are associated with said products 160. Providers 150 associated with the products 160 are able to change their retail prices for said products 160 and transmit those changes to the retail prices, via the supply chain network server 120, to database 110. Upon receiving an updated retail price for a product 160 from a provider 150, the second condition 217 displayed in any one of FIGS. 2B-2F, and 2G would display the updated retail price set by the provider 150.

In an embodiment, the second condition for acquisition includes at least one of: a price, a discount code, prescription information, refill information, usage instructions, a user acknowledgement selection, and third-party payer information. For example, the second condition 217 displayed in at least FIG. 2B may include the price set by provider 150, discount codes, requirements relating to prescription information, whether a prescription, specific to the user account 142, for the product 160 has been received from the provider 150, whether there are any refills for the prescription remaining, instructions for using the product 150, a request for a user to acknowledge product specific information before they can proceed to checkout, and information about the provider 150.

In an embodiment, the requested product or service is at least one of: a product that requires a prescription, a product that does not require a prescription, digital media, a telemedicine session or a medical service. For example, the product 160 selected in FIGS. 2A-2G is a prescription medicine, however the product 160 may also be a product that doesn't require a prescription (e.g., dog shampoo), digital media, a telemedicine session, or any other medical service.

In an embodiment, the method 300 may comprise the step of receiving, via the virtual marketplace server, user account data that includes information regarding one or more designated providers associated with one or more pets. For example, in FIGS. 2A-2B, a user may log into their account 142, and the retail marketplace server may receive the information associated with the user account 142 from the database. The information associated with the user account 142, including providers 150 associated with the pets associated with the user account 142, as discussed above with reference to FIG. 1C.

In an embodiment, the provider associated with the user-specific account is authorized by an entity other than the user to permit the user to access to the product or service. For example, the entity other than the user may be an insurance company which offers coverage for product 160a and not product 160b, product 160a being a less expensive alternative to product 160b. Thus, when a user 141 requests to access product 160b, the provider 150 is only authorized, by the insurance company, to offer the user 141 product 160a.

In an embodiment, the method 300 may comprise the step of in response to the user request, causing the user interface to display information about the product or service that includes identification information about an additional source for the product or service wherein the identification information is displayed in a manner that indicates the user is not authorized to obtain the product or service from the additional source. For example, in FIG. 2B, area 218 may be grayed out or include indicia indicating that the user associated with user account 142 is not authorized to purchase product 160 from provider 150.

In an embodiment, the provider is associated with the user-specific account based upon a previous transaction between the provider and one or more of an individual associated with the user-specific account and a pet associated with the user-specific account. For example, database 110 stores provider records 152 corresponding to providers 150 and user accounts 142, including previous transactions between the provider 150 and the user account 142 and the system 100 is configured to establish an association between the two based on the previous transaction, as discussed above with reference to FIG. 1C. In some embodiments, the previous transaction includes i) the writing of a prescription; ii) a transaction for the purchase of a good or service that is unrelated to the requested product or service; iii) a registration with the provider; and iv) obtaining an authorization code, as discussed above with reference to FIG. 1C.

In an embodiment, the user interface is coupled to a user device connected to the virtual retail marketplace server by one of a wide area network connection and a local area network connection. For example, the user interfaces displayed in FIGS. 2A-2G are displayed on a user device 140 connected to the supply chain network server 120 via a wide area network 130, shown in FIG. 1A.

In an embodiment, the first condition has a first value and second condition has a second value and first value is different from the second value. For example, in FIG. 2H, first condition 215b has a dollar amount value of $49.99 which is different from the dollar amount value of second condition 217b which is $52.99. In an embodiment, the first condition has a first value and second condition has a second value and first value is the same as the second value. For example, in FIG. 2H, first condition 215a and second condition 217a have the same dollar amount value of $49.99.

In an embodiment, the method 300 further includes the steps of receiving, at the virtual retail marketplace server, an order designating the selection of the provider as the source to provide the product or service, and verifying, via the selectable supply chain network server, that a prescription for the ordered product or service has been received for the product or service and the prescription is associated with the user specific account. For example, in FIG. 2F, after the user device has transmitted order placement request 252, the supply chain network server 120 queries the database 110 to check whether or not the provider 150 has included a prescription for product 160 and that the prescription is associated with the user account 142 that the user is currently logged in to when they submit the order placement request 252.

In an embodiment, the method 300 further includes the steps of receiving, on the selectable supply chain network server, a selection message indicating the provider associated with the user-specific account is a preferred source, and upon receiving, on the selectable supply chain network server, a future user request identifying an additional product or service, causing the user interface to display the provider as a default primary provider for the additional product or service. For example, referring to FIG. 1C, a user associated with user account 142a may update their account information to include that provider 150a is a preferred provider. In this example, the database 110 stores that indication that provider 150a is a preferred provider and the default purchasing source shown in FIG. 2E would be provider 150 instead of the host of the supply chain network server 120. In some embodiments, the method 300 may comprise the step of prior to causing the user interface to display the provider as a default primary provider for the additional product or service, verifying that the default primary provider has pre-selected the product or service for inclusion in a provider virtual marketplace. Continuing the example from above, the database 110 stores an association between provider 150a and products 160a and 160b. If the user had selected to display product 160n, preferred provider 150a would not display as the default provider in FIG. 2E.

In an embodiment, the method 300 further includes the step of receiving an order placement request (e.g., order placement request 252 in FIG. 2F), on the selectable supply chain network server, for a product to be sourced from the provider, the product requiring a prescription. In some embodiments, the method 300 may comprise the step of querying a database (e.g., order fulfillment request 254 in FIG. 2F), via the selectable supply chain network server, to verify that a valid prescription with sufficient refills have been associated with the order placement request. In some embodiments, the method 300 may comprise the step of recording in the database, an indication that inventory associated with the order has been transferred from a wholesale inventory associated with the selectable supply chain network server to a retail inventory of the provider. For example, database 110, in response to receiving the order fulfillment request 254, records an indication that inventory associated with the order (e.g., selected product 160 and the quantity thereof) has been transferred from a wholesale inventory associated with the selectable supply chain network server to a retail inventory for the selected provider 150. In some embodiments, the method 300 may comprise the step of receiving, in the database, an indication that the product has been shipped. For example, at a point in time after order confirmation UI 258 is displayed to the user in FIG. 2G, the product 160 included will ship. Once the product ships the database 110 will receive an information that the product 160 included in the order fulfillment request 254 has shipped and the database 110 records will be updated accordingly. In some embodiments, the method 300 may comprise the step of, transmitting to a provider server, from the selectable supply chain network server, a transaction message including information relating to provider product inventory status and a net proceeds transactions summary indicating a difference between accrued amounts associated with inventory transferred from the wholesale inventory associated with the selectable supply chain network server and accrued amounts associated with orders, to be sourced from the provider, that were placed with the selectable supply chain network server. For example, in response to receiving the order fulfillment request 254, the supply chain network server 120 transmits to the provider 150 a transaction message including the transaction summary.

In an embodiment, the user request includes one or more of: i) a search request; ii) selection via a menu; iii) a selection via hyperlink; and iv) selection via hyperlink in a digital message from a provider. For example, the user request 206 in FIG. 2A is in response to user input at location 204 on homepage UI 202. However, the user request 206 transmitted to supply chain network server 120 may also be in response to the user submitting a text entry in the search bar, a selection of a menu item displayed in FIG. 2A, a hyperlink displayed on a UI not shown in the figures, or a hyperlink included in an email received from a provider 150 (e.g., the user's veterinary clinic).

Referring to FIG. 4, there is shown, a flow diagram of a provider onboarding method 400. Onboarding may refer to an association between a provider and one or more products or services offered for sale on the supply chain network server 120. In an embodiment, method 400 may comprise step 402 of sending an invitation to a provider to join the program for supply chain management provided by the host of the retail marketplace server 120. Providers which are sent an invitation to the program may be selected based on any one of: a previous association with the host of the retail marketplace, or a record of the provider in a user account 142 stored in database 110 (e.g., user account 142n is associated with provider 150n which is not currently associated with any products 160 stored on database 110). The invitation may include information about the program including identifying information about the host of the retail marketplace server 120, why the provider has been invited to join the program, an overview of how the program works, and so on. The invitation may also include a hyperlink that the provider may select in order to begin the onboarding process if they so choose to.

In some embodiments, the method may comprise the step 404 of the provider selecting the hyperlink in the invitation to begin the onboarding process. The method may comprise the step 406 of, in response to the provider's selection of the hyperlink, the provider may be taken to a provider information user interface, received from the retail marketplace server 120 or another server associated with the host of the retail marketplace server 120. The provider information user interface may display a message indicating to the provider that information about the provider is being requested. The information being request may be at least one of: provider name, place of business, and type or classification of business. Alternatively, some or all of the information being requested may be automatically filled in and the provider may be given an opportunity to correct or update any of the information displayed in this manner. Once the provider has finished adding or updating the requested information, the provider may submit an indication that they are finished (e.g., via a button or hyperlink displayed on the provider information UI).

In some embodiments, the method may comprise the step 408 of, in response to the provider submitting the requested information, displaying an agreement to the provider and requesting that the provider sign the agreement. The provider may review the agreement and submit any questions or concerns about the agreement to the host of the retail marketplace server 120. The provider may also submit changes to the agreement for review by the host. After the provider has signed the agreement the onboarding process may continue. In some embodiments, the method 400 may include performing a practice management system (PIMS) integration of the provider 150 with the system 100.

In some embodiments, the method 400 may include the provider selecting pricing options (e.g., second condition 217) for products or services for sale on the retail marketplace server 120. The selected prices may be those that govern transactions on a private marketplace, for example the amount of currency required to purchase the product. Pricing options selection may be included in the onboarding process or completed after the onboarding process has been completed. In some embodiments, the provider may set pricing based on: a fixed price for each product or service it selects, a fixed discount level off a host pricing level (e.g., on a dollar basis or percentage basis) for selected product(s) that it selects, a fixed discount level of a host pricing level for all products that it selects or combinations thereof. For example, the provider may select the price at which the provider wishes to offer products for sale on the retail marketplace server, opt out of an association with specific products, or submit a request for new products. The provider may select an option to default their pricing to match the hosts pricing (e.g., the first condition 215 and second condition 217 having the same value). The provider may select to default their pricing to be a percentage or dollar amount above or below the host pricing. For example, the provider may select to default their pricing to +/−5%, +/−10%, +/−15%, or +/−20% the hosts listed retail price. The provider may also alter pricing on a per product basis. For example, the provider may offer product 160a at the same retail price as the host but offer product 160b at a 5% increased price with respect to the retail price as set by the host. The pricing and product options selected by the provider may be changed by the provider at any time after completing the onboarding process.

In some embodiments, the method 400 may comprise the step 410 of requesting banking information from the provider so that proceeds from purchases on the retail marketplace server 120 which identifies the provider as the desired source for the purchased product or service may be directed to the provider. In some embodiments, once the provider has finished providing banking information, all selections and information from the provider are transmitted to the host of the retail marketplace server 120.

In some embodiments, the method 400 may comprise the step 412 of, processing the information and selections from the provider. The host receives the information and processes the information to ensure all necessary information has been received. The host may correspond with the provider if any necessary information is missing or needs clarification. Once the host has processed the provider information, the host may either approve or deny the providers request to join the program.

In some embodiments, the method 400 may comprise the step 414 of sending an end user license agreement (EULA) to the provider. The EULA may be sent to the provider in response to the host approving the providers request to join the program. The EULA may not be sent to the provider in response to the host denying the providers request to join the program. Once the provider executes the EULA the automated onboarding process is completed and database 110 is updated to include an association of the provider with the product(s) 160 having corresponding product records 162 included in the database 110.

Referring to FIG. 5, a flow diagram depicting another embodiment of an onboarding method 500 for providers 150 is shown. The method 500 includes steps which are similar to the method 400 for onboarding providers 150. The method 500 includes steps, with regards to the method 400, that are optional. In some embodiments, the method 500, includes the step 502 of verifying the provider information (e.g., provider information input by provider 150 in step 406 of method 400) through an authorized third party (e.g., an entity which has record of and/or is able to verify the provider information). In some embodiments, the method 500 includes the step 504 of having the provider 150 sign a master service agreement (MSA). In some embodiments, the provider 150 opts not to sign the MSA and the method 500 further includes the step 506 of processing questions, issues, and addendums presented by the provider 150 in regards to the MSA. In some embodiment, the method 500 includes the step 508 of submitting a request to the host of the supply chain network to include the provider 150 (e.g., a veterinarian clinic) in the system 100, and including the provider 150 via a user-interface generated by the supply chain network server 120, in the system 100. In some embodiments, the method 500, includes the step 510 of determining whether or not the provider 150 wants to do a PIMS integration. In some embodiments, if the provider 150 chooses to proceed with the PIMS integration, the provider 150 is sent an end user license agreement to sign. In some embodiments, the onboarding process is only complete once the provider 150 signs and submits the end user license agreement. In some embodiments, if the provider 150 chooses not to proceed with the PIMS integration the onboarding process is complete.

In one embodiment of the invention, there is a method for controlling access to a supply chain comprising: receiving, on a supply chain network server, a user request identifying a product or service; and in response to the user request, causing a user interface to display information about the product or service that includes identification information about two or more distinct sources for the product or service, the two or more distinct sources including no more than i) a host of the supply chain network server; and ii) a provider associated with a user-specific account.

In one aspect of the method the information about the product or service further includes a) a first condition for acquisition of the product or service preselected by the host of the supply chain network server, and b) a second condition for acquisition of the product or service preselected by the provider associated with the user-specific account.

In one aspect other method also includes: displaying the first condition proximate identification information of the host of the supply chain network server; and simultaneously with the displaying of the first condition, displaying the second condition proximate identification information of the provider associated with user-specific account information.

In any one of the foregoing embodiments or aspects, the method may also include, prior to causing the display of the identification information about the provider associated with the user-specific account, displaying on the user interface a prompt to associate the user-specific account with the provider.

In any one of the foregoing embodiments or aspects, the prompt includes one or more of: a drop-down menu, a dialog box, a login screen and an icon.

In any one of the foregoing embodiments or aspects, the method also includes verifying that the provider is authorized by the host of the supply chain network server to provide products or services via a marketplace server; and verifying that the provider has authorized association with a user.

In any one of the foregoing embodiments or aspects, the method also includes automatically associating the user request with a prescription authorization from the provider.

In any one of the foregoing embodiments or aspects, the method also includes storing in a database, coupled to the supply chain network server, the first condition for acquisition of the product or service and the second condition for acquisition of the product or service; verifying, via the supply chain network server, that the provider is authorized to change the second condition for acquisition; receiving, via the supply chain network server, an updated second condition for acquisition; and storing in the database coupled to the supply chain network server, the updated second condition for acquisition; wherein causing the user interface to display information about the product or service includes displaying the second condition for acquisition.

In any one of the foregoing embodiments or aspects of the method, the second condition for acquisition includes at least one of: a price, a discount code, prescription information, refill information, usage instructions, a user acknowledgement selection, and third party payer information.

In any one of the foregoing embodiments or aspects of the method, the requested product or service is at least one of: a pharmaceutical product that requires a prescription, a product that does not require a prescription, digital media, or a telemedicine session.

In any one of the foregoing embodiments or aspects, the method also includes receiving, via the supply chain network server, user account data that includes information regarding one or more designated providers associated with one or more pets.

In any one of the foregoing embodiments or aspects of the method, the provider associated with the user-specific account is authorized by an entity other than the user to permit the user to access to the product or service.

In any one of the foregoing embodiments or aspects, the method also includes: in response to the user request, causing the user interface to display information about the product or service that includes identification information about an additional source for the product or service wherein the identification information is displayed in a manner that indicates the user is not authorized to obtain the product or service from the additional source.

In any one of the foregoing embodiments or aspects of the method, the provider is associated with the user-specific account based upon a previous transaction between the provider and one or more of an individual associated with the user-specific account and a pet associated with the user-specific account.

In any one of the foregoing embodiments or aspects of the method, the previous transaction includes i) writing of a prescription; ii) a transaction for the purchase of a good or service that is unrelated to the requested product or service; iii) a registration with the provider; and iv) obtaining an authorization code.

In any one of the foregoing embodiments or aspects of the method, the user interface is coupled to a user device connected to the supply chain network server by one of a wide area network connection and a local area network connection.

In any one of the foregoing embodiments or aspects of the method, the first condition has a first value and second condition has a second value and first value is different from the second value.

In any one of the foregoing embodiments or aspects of the method, the first condition has a first value and second condition has a second value and first value is the same as the second value.

In any one of the foregoing embodiments or aspects, the method also includes receiving, at the supply chain network server, an order designating the selection of the provider as the source to provide the product or service; and verifying, via the supply chain network server, that a prescription for the ordered product or service has been received for the product or service and the prescription is associated with the user specific account.

In any one of the foregoing embodiments or aspects, the method also includes receiving, on the supply chain network server, a selection message indicating the provider associated with the user-specific account is a preferred source; and upon receiving, on the supply chain network server, a future user request identifying an additional product or service, causing the user interface to display the provider as a default primary provider for the additional product or service.

In any one of the foregoing embodiments or aspects, the method also includes: prior to causing the user interface to display the provider as a default primary provider for the additional product or service, verifying that the default primary provider has pre-selected the product or service for inclusion in a provider virtual marketplace.

In any one of the foregoing embodiments or aspects, the method also includes receiving on the supply chain server an indication that a new user and an authorized provider are associated with a transaction initiated on a separate network coupled to the supply chain network; and in response to receive the indication, creating a user record for the new user via the supply chain network server and associated the authorized provider with the user record.

In any one of the foregoing embodiments or aspects, the method also includes receiving an order placement request, on the supply chain network server, for a product to be sourced from the provider, the product requiring a prescription; querying a database, via the supply chain network server, to verify that a valid prescription with sufficient refills have been associated with the order placement request; recording in the database, an indication that inventory associated with the order has been transferred from a wholesale inventory associated with the supply chain network server to a retail inventory of the provider; receiving, in the database, an indication that the product has been shipped; and transmitting to a provider server, from the supply chain network server, a transaction message including information relating to provider product inventory status and a net proceeds transactions summary indicating a difference between accrued amounts associated with inventory transferred from the wholesale inventory associated with the supply chain network server and accrued amounts associated with orders, to be sourced from the provider, that were placed with the supply chain network server.

In any one of the foregoing embodiments or aspects of the method, the user request includes one or more of: i) a search request; ii) selection via a menu; iii) a selection via hyperlink; and iv) selection via hyperlink in a digital message from a provider.

In one embodiment of the invention, there is a system configured to perform one or more of the embodiments or aspects of the methods described above.

In one embodiment, there is a non-transitory computer readable storage medium storing one or more programs, the one or more programs comprising instructions which, when executed by an electronic device performs one or more of the embodiments or aspects of the method described above.

It will be appreciated by those skilled in the art that changes could be made to the exemplary embodiments shown and described above without departing from the broad inventive concepts thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

1. A method for controlling access to a supply chain comprising:
receiving, on a supply chain network server, a user request identifying a product or service; and
in response to the user request, causing a user interface to display information about the product or service that includes identification information about two or more distinct sources for the product or service, the two or more distinct sources including no more than i) a host of the supply chain network server; and ii) a provider associated with a user-specific account,
wherein the information about the product or service further includes a) a first condition for acquisition of the product or service preselected by the host of the supply chain network server, and b) a second condition for acquisition of the product or service preselected by the provider associated with the user-specific account.

2. (canceled)

3. The method of claim 1 further comprising:
displaying the first condition proximate identification information of the host of the supply chain network server; and
simultaneously with the displaying of the first condition, displaying the second condition proximate identification information of the provider associated with user-specific account information.

4. The method of claim 1 further comprising:
prior to causing the display of the identification information about the provider associated with the user-specific account, displaying on the user interface a prompt to associate the user-specific account with the provider.

5. The method of claim 4 wherein the prompt includes one or more of: a drop-down menu, a dialog box, a login screen and an icon.

6-7. (canceled)

8. The method of claim 1 further comprising:
storing in a database, coupled to the supply chain network server, the first condition for acquisition of the product or service and the second condition for acquisition of the product or service;
verifying, via the supply chain network server, that the provider is authorized to change the second condition for acquisition;
receiving, via the supply chain network server, an updated second condition for acquisition; and
storing in the database coupled to the supply chain network server, the updated second condition for acquisition;
wherein causing the user interface to display information about the product or service includes displaying the second condition for acquisition.

9. The method of claim 8 wherein the second condition for acquisition includes at least one of: a price, a discount code, prescription information, refill information, usage instructions, a user acknowledgement selection, and third party payer information.

10. The method of claim 1, wherein the requested product or service is at least one of: a pharmaceutical product that requires a prescription, a product that does not require a prescription, digital media, or a telemedicine session.

11. The method of claim 1, further comprising:
receiving, via the supply chain network server, user account data that includes information regarding one or more designated providers associated with one or more pets.

12. (canceled)

13. The method of claim 1, further comprising
in response to the user request, causing the user interface to display information about the product or service that includes identification information about an additional source for the product or service wherein the identification information is displayed in a manner that indicates the user is not authorized to obtain the product or service from the additional source.

14. The method of claim 1, wherein the provider is associated with the user-specific account based upon a previous transaction between the provider and one or more of an individual associated with the user-specific account and a pet associated with the user-specific account.

15. The method of claim 14, wherein the previous transaction includes i) writing of a prescription; ii) a transaction for the purchase of a good or service that is unrelated to the requested product or service; iii) a registration with the provider; and iv) obtaining an authorization code.

16. The method of claim 1, wherein the user interface is coupled to a user device connected to the supply chain network server by one of a wide area network connection and a local area network connection.

17. The method of claim 1, wherein the first condition has a first value and second condition has a second value and first value is different from the second value.

18. The method of claim 1, wherein the first condition has a first value and second condition has a second value and first value is the same as the second value.

19. The method of claim 1 further comprising:
receiving, at the supply chain network server, an order designating the selection of the provider as the source to provide the product or service; and
verifying, via the supply chain network server, that a prescription for the ordered product or service has been received for the product or service and the prescription is associated with the user specific account.

20. The method of claim 1 further comprising:
receiving, on the supply chain network server, a selection message indicating the provider associated with the user-specific account is a preferred source; and
upon receiving, on the supply chain network server, a future user request identifying an additional product or service, causing the user interface to display the provider as a default primary provider for the additional product or service.

21. The method of claim 20 further comprising:
prior to causing the user interface to display the provider as a default primary provider for the additional product or service, verifying that the default primary provider has pre-selected the product or service for inclusion in a provider virtual marketplace.

22. The method of claim 1 further comprising:
receiving on the supply chain server an indication that a new user and an authorized provider are associated with a transaction initiated on a separate network coupled to the supply chain network; and
in response to receive the indication, creating a user record for the new user via the supply chain network server and associated the authorized provider with the user record.

23. The method of claim 1 further comprising:
receiving an order placement request, on the supply chain network server, for a product to be sourced from the provider, the product requiring a prescription;
querying a database, via the supply chain network server, to verify that a valid prescription with sufficient refills have been associated with the order placement request;
recording in the database, an indication that inventory associated with the order has been transferred from a wholesale inventory associated with the supply chain network server to a retail inventory of the provider;
receiving, in the database, an indication that the product has been shipped; and
transmitting to a provider server, from the supply chain network server, a transaction message including information relating to provider product inventory status and a net proceeds transactions summary indicating a difference between accrued amounts associated with inventory transferred from the wholesale inventory associated with the supply chain network server and accrued amounts associated with orders, to be sourced from the provider, that were placed with the supply chain network server.

24. The method of claim 1 wherein the user request includes one or more of: i) a search request; ii) selection via a menu; iii) a selection via hyperlink; and iv) selection via hyperlink in a digital message from a provider.
